(19) United States
(12) Patent Application Publication
(10) Pub. No.: US 2003/0102067 A1
(43) Pub. Date: Jun. 5, 2003

(54) PNEUMATIC RADIAL TIRES

(76) Inventors: YOICHI OKAMOTO, KAWAGOE CITY (JP); YOSHIHIDE KOHNO, TOKYO (JP)

Correspondence Address: SUGHRUE MION ZINN MACPEAK & SEAS, 2100 PENNSYLVANIA AVENUE NW, WASHINGTON, DC, 20037

(21) Appl. No.: 09/398,006

(22) Filed: Sep. 16, 1999

(30) Foreign Application Priority Data
Sep. 17, 1998 (JP) 10-263,224
Sep. 17, 1998 (JP) 10-263,226
Dec. 11, 1998 (JP) 10-352,375
Dec. 11, 1998 (JP) 10-352,376
Dec. 24, 1998 (JP) 10-366,507

(51) Int. Cl. B60C 9/18; B60C 9/20

(52) U.S. Cl. 152/532; 152/526; 152/534; 152/537; 152/538

(57) ABSTRACT

A pneumatic radial tire comprises a radial carcass of at least one rubberized cord ply, a belt comprised of three rubberized cord layers, an innermost cord layer and a middle cord layer among these cord layers being a cross cord layer that cords of the layers are crossed with each other with respect to an equatorial plane of the tire, and one or more circumferential grooves provided in at least each side region of the tread portion, wherein the cords of each of the innermost cord layer and the middle cord layer have an inclination angle of 10-25° with respect to an equatorial plane of the tire, and cords of an outermost cord layer have an inclination angle of 45-115° with respect to the equatorial plane and the outermost cord layer has a width extending toward an end of the tread portion over an outermost groove edge of an outermost circumferential groove in a widthwise direction of the tread portion.

### BACKGROUND OF THE INVENTION

1. Field of the Invention

This invention relates to a pneumatic radial tire, and more particularly to a heavy duty pneumatic radial tire for use in heavy vehicles such as trucks, buses and the like, which has a belt comprised of three rubberized cord layers for attaining weight reduction and improves a cut resistance in a tread portion, particularly cut resistance of a belt to enhance a durability during the running on bad road while maintaining separation resistance of the belt, cornering performance and the like at a level equal to or more than those of the conventional tire having a belt comprised of four rubberized cord layers.

2. Description of Related Art

In this type of the tire, particularly pneumatic radial tire for use in a heavy vehicle such as truck, bus or the like, as shown in FIG. 1, a belt 2 in a tread portion 1 is generally comprised of four rubberized cord layers 3, 4, 5, 6, wherein cords in a first cord layer 3 located nearest to a carcass 8 are arranged at a relatively large inclination angle with respect to a plane parallel to an equatorial plane E of the tire, and cords of second cord layer 4 and third cord layer 5 are arranged so as to cross with each other with respect to the above plane to form a cross cord layer 7 composed of the second and third cord layers 4, 5, and cords in a fourth cord layer 6 are arranged in the same extending direction as the third cord layer 5 at substantially the same inclination angle as in the third cord layer 5. Moreover, steel cords are used in each of the cord layers 3 to 6 constituting the belt 2.

When the tire having the above belt 2 is run on a bad road, e.g. a bad road scattered with broken stones, small rocks and the like under loading, the tread portion 1 tread on sharp corner edge portion of the broken stone, small rock or the like and is occasionally subjected to cut damage reaching to the belt 2. In order to avoid the fatal trouble of the belt through the cut damage as far as possible, it is proposed that the fourth cord layer 6 plays a role as a protection layer for holding the cut damage of the belt at the fourth cord layer 5 as an outermost cord layer.

On the other hand, it is strongly demanded to reduce the weight of the heavy duty pneumatic radial tire likewise pneumatic radial tires for passenger car and the like. For this purpose, there is a proposal that the belt occupying a greater part in the tire weight is rendered from the above four-layer structure into three-layer structure. In the belt having the three cord layers, cords in a first cord layer located nearest to a carcass are arranged at a relatively large inclination angle with respect to the above plane, and second cord layer and third cord layer form a cross cord layer and cords of the cross cord layer are arranged at a relatively small inclination angle with respect to the plane.

As the tire having such a three-layer structure, for example, a tire disclosed in JP-A-7-186613 has a belt comprised of three breakers (corresponding to the cord layer), wherein a tenacity of a third breaker counted from the carcass per unit width is made larger than those of first and second breakers under such a knowledge that the tenacity of the third breaker is most lacking. Thus, when the tread portion of the tire rides on foreign matter such as broken stones, small rocks and the like, troubles stops only the cord breakage in the third breaker at most, whereby fatal troubles such as burst and the like can cheaply and effectively be prevented.

As a result of actual investigations on the tire disclosed in the above publication, however, it has been confirmed that since the cross cord angle between the second and third breakers constituting the cross cord layer in the belt is relatively small, when the tire is inflated under a given inner pressure, a large tension is applied to the cords of each of the second and third breakers, so that even if the cord tenacity of the third breaker per unit width (concretely tensile strength) is increased with considerable effort, the cord breakage through the foreign matter such as broken stones, small rocks or the like can not sufficiently be controlled. Because, the cords subjected to the large tension largely decrease energy enough to counter to input of cut damage.

As shown by a partial front view of the above tire (three cord layers 11, 12, 13 constituting a belt 10) in FIG. 2, when the tread portion 14 of the tire run under loading rides on a certain size of a foreign matter 16 such as broken stone or rock, a bending force is applied to the belt 10 in a direction of an arrow 17 and hence a buckling phenomenon is apt to be locally caused in the cords of an outermost cord layer 13. As the buckling is repeatedly caused, the fatigue of the cord is promoted to finally cause a trouble of breaking the cord. And also, if the running of the tire is continued at such a state, the other cord layers 11, 12 in the belt 10 are damaged and finally the separation failure of the belt 10 is caused and hence it is impossible to reuse the tire.

Furthermore, among grooves formed in a tread rubber for the formation of a tread pattern, when a sharp corner edge portion of the broken stone or small rock bites into a circumferential groove extending in the circumferential direction of the tread portion at each side region of the tread portion in the riding of the tire on the foreign matter, since a thickness of the tread rubber from the bottom of such a circumferential groove to the belt is thin, the above sharp corner edge portion relatively easily passes through the tread rubber and arrives at the belt and hence the belt is easily cut by the sharp corner edge portion of the broken stone or the like. Therefore, the cut damage of the belt in such a circumferential groove should be solved.

In general, the pneumatic radial tires for use in a heavy vehicle such as truck, bus or the like are repeatedly subjected to recapping in accordance with user's demands for cost saving and resource saving. For this end, it is required to cause no fatal cut damage or cord breakage in the belt 10 and no large separation failure around the belt 10 as a tire suitable for the recapping.

Moreover, in the conventional tire shown in FIG. 1, the first cord layer 3 containing cords arranged at a relatively large inclination angle is an innermost cord layer, while the inclination angle of the cord in the second to fourth cord layers 4, 5, 6 with respect to the equatorial plane E is small, so that when a top of a rib formed in a mold for the formation of a circumferential groove 9 bites into an uncured tread rubber of a tread portion in an uncured tire during the vulcanization building of the uncured tire, since the bending rigidity of a laminate of uncured cord layers is small, the bending resistance of the laminate to the entrance of the rib top of the mold is insufficient and hence the portion of the belt 20 just beneath the circumferential groove 9 indicates concave form in the resulting product tire as shown in FIG. 1. Such a concave form in the cord layers 5, 6 has a problem that the recapping operation is considerably degraded because the rib top is hardly peeled off from the concave form.

Particularly, in the tire having the belt of three-layer structure as shown in FIG. 2, the bending resistance (i.e. rigidity) of the belt as a laminate is smaller than that of the conventional tire having the belt of four-layer structure as shown in FIG. 1, and the degree of the concave form in the cord layers 12, 13 becomes larger than that of the conventional tire. In the recapping of the tire, therefore, it is required that the cut damage is stopped to an extremely small level as far as possible, and the cord breakage is hardly caused, and the separation at the end portion of the belt is stopped to a slight cracking level, and the recapping operation is good. However, these requirements are not satisfied in the conventionally proposed tires having the belt of three-layer structure at all.

### SUMMARY OF THE INVENTION

It is, therefore, an object of the invention to provide a long-life pneumatic radial tire rendering a belt into a structure of three rubberized cord layers for holding weight reduction and improving performances required for the tire such as separation resistance of belt, cornering performance and the like at a level equal to or more than those of the conventional tire having a belt comprised of four rubberized cord layers and capable of simultaneously and largely improving cut resistance of belt as a whole of the tire including cut resistance in a circumferential groove of a tread pattern during the running on bad road and fatigue resistance of cords in an outermost cord layer constituting the belt.

In is another object of the invention to facilitate peeling-off of a top of a rib in a mold for the formation of a circumferential groove from a concaved cord layer constituting the belt in the recapping of the tire to improve the recapping operation.

According to a first aspect of the invention, there is the provision of a pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane of the tire, and one or more circumferential grooves provided in at least each side region of the tread portion, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and the outermost cord layer has a width extending toward an end of the tread portion over an outermost groove edge of an outermost circumferential groove in a widthwise direction of the tread portion.

In a preferable embodiment of the first aspect, a coating rubber for the cords of the outermost cord layer has a compression modulus of not less than 200 kgf/cm². Thus, the resistance to buckling fatigue in the cord of the outermost cord layer is improved.

In another preferable embodiment of the first aspect, the outermost cord layer has a width covering both widthwise ends of the middle cord layer, preferably a width corresponding to 1.0-1.2 times the width of the middle cord layer. Thus, the separation resistance at the end portion of the belt, particularly cord-crossed end portion causing the concentration of shearing strain is more improved.

In the other preferable embodiment of the first aspect, a rubber gauge between the cord at an end portion of the middle cord layer and the cord of the outermost cord layer adjacent thereto is not less than 0.15 time a rubber gauge between the cord at the end portion of the middle cord layer and the cord of the innermost cord layer adjacent thereto. Thus, the above improvement of the separation resistance is more enhanced.

In a further preferable embodiment of the first aspect, an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm. Thus, the separation resistance at the end portion of the cross cord layer is more advantageously attained.

In a still further preferable embodiment of the first aspect, at least one of the innermost cord layer and the middle cord layer is provided with a rubber layer joined to a widthwise end face of the cord layer over a full periphery of the cord layer, and the rubber layer has a width of 0.05-5.00 mm.

According to a second aspect of the invention, there is the provision of a pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and at least two circumferential grooves provided in at least a central region of the tread portion, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and a cord layer line passing through a center of a thickness of the outermost cord layer at a radial section of the tire is either one of a curved line and a combined line of a curved line and a straight line, and a maximum distance from the cord layer line to a line segment connecting two intersects between the cord layer line and each of extended lines equally dividing a groove width of each of the adjoining circumferential grooves at a radial section of the tire having a state of fitting an outer width between the pair of the bead portions to a width of an approved rim is not more than 1 mm.

The term “approved rim” used herein means a standard rim (or approved rim or recommended rim) in an approved size described in a standard as mentioned later. That is, the standard is determined according to an industrial standard in an area manufacturing or using tires and defined, for example, by Year Book of The Tire and Rim Association Inc. in USA, Standard Manual of The European Tire and Rim Technical Organization in Europe, or JATMA Year Book in Japan.

In a preferable embodiment of the second aspect, a coating rubber for the cords of the outermost cord layer has a compression modulus of not less than 200 kgf/cm². Thus, the resistance to buckling fatigue in the cord of the outermost cord layer is improved.

In another preferable embodiment of the second aspect, the cord layer line has a center of curvature located inward in the radial direction of the tire over a full width of the outermost cord layer. When the cord layer line is a composite curved line, it is represented by a curvature center of the curved line.

The cord layer line and maximum distance as mentioned above can be realized by properly selecting the inclination angle of the cord in each cord layer constituting the belt within the above defined range. They are more surely attained by using an uncured tread rubber having grooves previously formed at positions contacting with ribs of a mold for the formation of circumferential grooves in the manufacture of an uncured tire, or by approaching a ratio of an outer circumference of a belt in a cured tire to an outer circumference of a belt member in an uncured tire to 1 as far as possible, or by rendering an end count of cords in each cord layer constituting a belt of a cured tire into not less than 18 cords/50 mm.

According to a third aspect of the invention, there is the provision of a pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and a tread portion provided with a plurality of lateral grooves extending from an inside of the tread portion toward an end thereof, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and an inclination angle of a center line of a groove width of the lateral groove with respect to a plane parallel to the equatorial plane has an inclination angle difference of not less than 20° with respect to an axial line of the cord in the outermost cord layer having the above inclination angle with respect to the equatorial plane.

In a preferable embodiment of the third aspect, a coating rubber for the cords of the outermost cord layer has a compression modulus of not less than 200 kgf/cm². Thus, the resistance to buckling fatigue in the cord of the outermost cord layer is improved.

In another preferable embodiment of the third aspect, the center line of the groove width of the lateral groove is crossed with the axial line of the cord in the outermost cord layer with respect to the plane parallel to the equatorial plane because there is an important relation between the arranging direction of the lateral groove and the cord arranging direction of the outermost cord layer.

In the other preferable embodiment of the third aspect, an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm. Thus, the separation resistance at the end portion of the cross cord layer is more advantageously attained.

In a further preferable embodiment of the third aspect, at least one of the innermost cord layer and the middle cord layer is provided with a rubber layer joined to a widthwise end face of the cord layer over a full periphery of the cord layer, and the rubber layer has a width of 0.05-5.00 mm.

According to a fourth aspect of the invention, there is the provision of a pneumatic radial tire comprising a radial carcass comprised of at least one rubberized cord ply extending between a pair of bead cores embedded in a pair of bead portion and reinforcing a pair of sidewall portions and a tread portion and a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, characterized in that the cords of each of the innermost cord layer and the middle cord layer have an inclination angle of 10-25° with respect to the equatorial plane, and cords of an outermost cord layer are high-extensible cords and have an inclination angle of 45-115° with respect to the equatorial plane as measured in the same direction as in the cords of the middle cord layer.

In a preferable embodiment of the fourth aspect, a coating rubber for the cords of the outermost cord layer has a compression modulus of not less than 200 kgf/cm². Thus, the resistance to buckling fatigue in the cord of the outermost cord layer is improved.

In another preferable embodiment of the fourth aspect, the high-extensible cord has an elongation at break of not less than 4%. The term “high-extensible cord” used herein means a strand rope having such a structure that n filaments (n: integer) are twisted to form a strand and m strands (m: integer) are twisted together in the same direction, so-called open type cord formed by twisting 1 filaments (1: integer) each subjected to a forming so as to exceed a diameter of a cord compactly twisted together and the like. The value of elongation at break of the cord is determined by dividing displacement at break when the cord taken out from the tire is pulled by means of an Instron tension testing machine by a distance between chucks before the pulling.

In the other preferable embodiment of the fourth aspect, an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm. Thus, the separation resistance at the end portion of the cross cord layer is more advantageously attained.

In a further preferable embodiment of the fourth aspect, at least one of the innermost cord layer and the middle cord layer is provided with a rubber layer joined to a widthwise end face of the cord layer over a full periphery of the cord layer, and the rubber layer has a width of 0.05-5.00 mm.

According to a fifth aspect of the invention, there is the provision of a pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and a pair of circumferential shoulder grooves formed on at least both side regions of the tread portion, characterized in that the cords of each of the innermost cord layer and the middle cord layer have an inclination angle of 10-25° with respect to the equatorial plane, and cords of an outermost cord layer are high-extensible cords and have an inclination angle of 45-115° with respect to the equatorial plane as measured in the same direction as in the cords of the middle cord layer, and the outermost cord layer has a width narrower than a width between groove edges of the circumferential shoulder grooves nearest to the equatorial plane.

In a preferable embodiment of the fifth aspect, a coating rubber for the cords of the outermost cord layer has a compression modulus of not less than 200 kgf/cm². Thus, the resistance to buckling fatigue in the cord of the outermost cord layer is improved.

In another preferable embodiment of the fifth aspect, two circumferential central grooves extending so as to sandwich the equatorial plane of the tire therebetween are arranged in a central region of the tread portion and the width of the outermost cord layer is wider than a width between groove edges of the circumferential central grooves farthest from the equatorial plane.

In the invention, when a tread surface width of the tread portion is divided into four equal parts, two equal parts sandwiching the equatorial plane of the tire indicate the central region of the tread portion and the remaining two equal parts located outside the central region indicate both side regions of the tread portion. And also, the cross cord layer indicates a lamination structure of adjoining cord layers that the cords of these cord layers are arranged in different directions with respect to the equatorial plane of the tire (upward to the right and upward to the left). Furthermore, steel cords are favorably used in the cord ply of the carcass and each cord layer of the belt.

As the compression modulus of the coating rubber is used a value calculated according to the following method. That is, a rubber specimen 20 is closely filled in a metal jig 21 or a steel jig having a columnar hollow portion with a diameter d of 14 mm and a height h of 28 mm as shown in FIG. 3, and then the jig 21 is set in a compression testing machine 22 as shown in FIG. 4. Thereafter, a load W is applied to upper and lower faces of the rubber specimen 20 at a rate of 0.6 mm/min, during which a displacement of the rubber specimen 20 is measured by means of a laser displacement meter 23. Then, the compression modulus is calculated from a relation of the measured displacement to the load W.

### BRIEF DESCRIPTION OF THE DRAWINGS

The invention will be described with reference to the accompanying drawings, wherein:

FIG. 1 is a diagrammatically left-half section view of a main part of the conventional tire;

FIG. 2 is a diagrammatic view illustrating a deformed state of a belt having a three-layer structure in the conventional tire when the tire rides on a large foreign matter;

FIG. 3 is a perspective view of a jig used for the measurement of compression modulus of rubber according to the invention;

FIG. 4 is a front view of a compression testing machine fitted with the jig shown in FIG. 3;

FIG. 5 is a perspective view partly cutaway of a part of a tread portion in a first embodiment of the pneumatic radial tire according to the invention;

FIG. 6 is a partially developed plan view of the tread portion in the tire of FIG. 5;

FIG. 7 is a graph showing a relation between inclination angle of cord in an outermost cord layer and cornering power of tire;

FIG. 8 is a partially developed plan view of another tread portion in the tire of FIG. 5;

FIG. 9 is a perspective view of an end portion of a cross cord layer in the belt of the tire shown in FIG. 8;

FIG. 10 is a diagrammatically enlarged section view of the end portion of the cross cord layer shown in FIG. 9;

FIG. 11 is a perspective view of an end portion of another cross cord layer in the belt of the tire shown in FIG. 8;

FIG. 12 is a diagrammatically section view of a second embodiment of the pneumatic radial tire according to the invention;

FIG. 13 is a developed plan view of cord layers constituting a belt in the tire shown in FIG. 12;

FIG. 14 is a diagrammatically enlarged section view of a main part at a central region of a tread portion in the tire shown in FIG. 12;

FIG. 15 is a diagrammatically enlarged section view of a main part at a part of central region and side region of a tread portion in the tire shown in FIG. 12;

FIG. 16 is a perspective view partly cutaway of a part of a tread portion in a third embodiment of the pneumatic radial tire according to the invention;

FIG. 17 is a partially developed plan view of the tread portion in the tire of FIG. 16;

FIG. 18 is a perspective view of an end portion of a cross cord layer in the belt of the tire shown in FIG. 16;

FIG. 19 is a diagrammatically enlarged section view of the end portion of the cross cord layer shown in FIG. 18;

FIG. 20 is a perspective view of an end portion of another cross cord layer in the belt of the tire shown in FIG. 16;

FIG. 21 is a perspective view partly cutaway of a part of a tread portion in a fourth embodiment of the pneumatic radial tire according to the invention;

FIG. 22 is a developed plan view of cord layers constituting a belt in the tire shown in FIG. 21;

FIG. 23 is a perspective view partly cutaway of a part of a tread portion in a fifth embodiment of the pneumatic radial tire according to the invention; and

FIG. 24 is a developed plan view of cord layers constituting a belt in the tire shown in FIG. 23.

### DESCRIPTION OF PREFERRED EMBODIMENTS

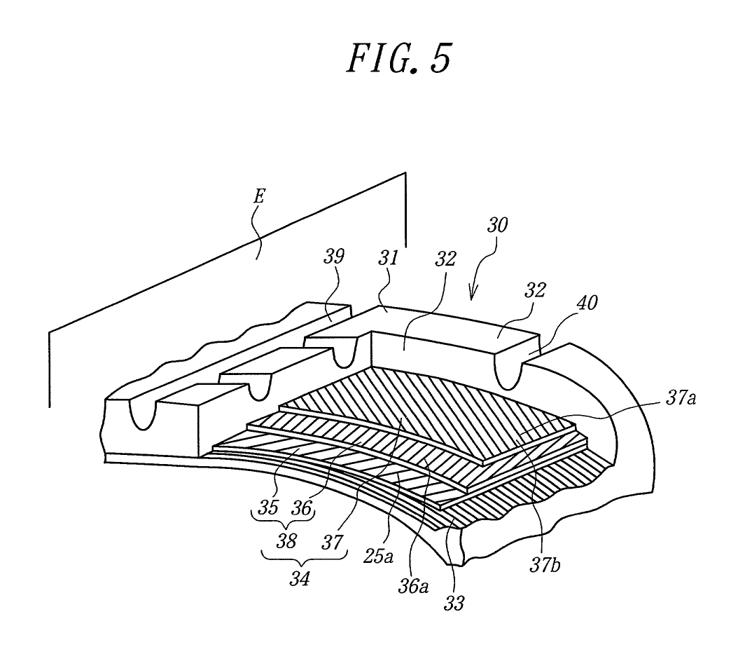

In FIG. 5 is shown a first embodiment of the heavy duty pneumatic radial tire according to the invention. This tire 30 comprises a pair of bead portions (not shown), a pair of sidewall portions (not shown) and a tread portion 31 extending between the pair of the sidewall portions and provided on its ground contact side with a tread rubber 32. And also, the tire 30 comprises a radial carcass 33 extending between a pair of bead cores (not shown) embedded in the bead portions to reinforce the pair of the bead portions and the pair of the sidewall portions and the tread portion and comprised of one or more rubberized cord plies, one cord ply in the illustrated embodiment and a belt 34 arranged on an outer circumference of the carcass 33 to reinforce the tread portion 31.

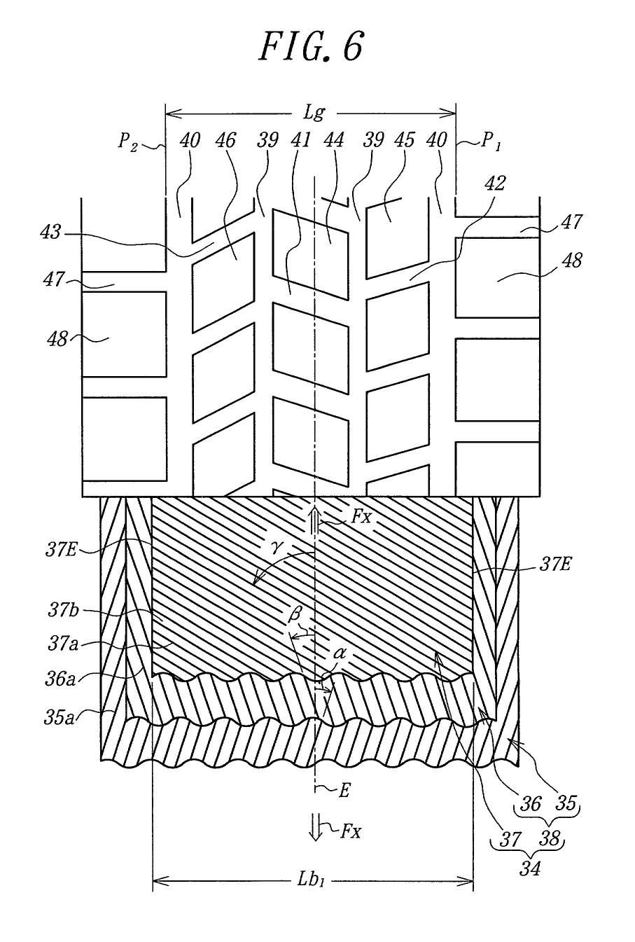

Referring to FIGS. 5 and 6, the belt 34 is comprised of three rubberized cord layers 35, 36, 37, wherein cords 35a, 36a of each of an innermost cord layer 35 nearest to the carcass 33 and a middle cord layer 36 are crossed with each other with respect to an equatorial plane E of the tire and the innermost cord layer 35 and the middle cord layer 36 form a cross cord layer 38. The cords 35a of the innermost cord layer 35 and the cords 36a of the middle cord layer 36 are arranged at an inclination angle (α, β) of 10-25°, preferably 15-22° with respect to the equatorial plane E, respectively. On the other hand, cords 37a of an outermost cord layer 37 are arranged at an inclination angle (β) of 45-115°, preferably 50-100° with respect to the equatorial plane E as measured in the same direction as the inclination angle β of the cord 36a of the middle cord layer 36. And also, the cord 37a in the outermost cord layer 37 is covered with a coating rubber having a compression modulus of not less than 200 kgf/cm².

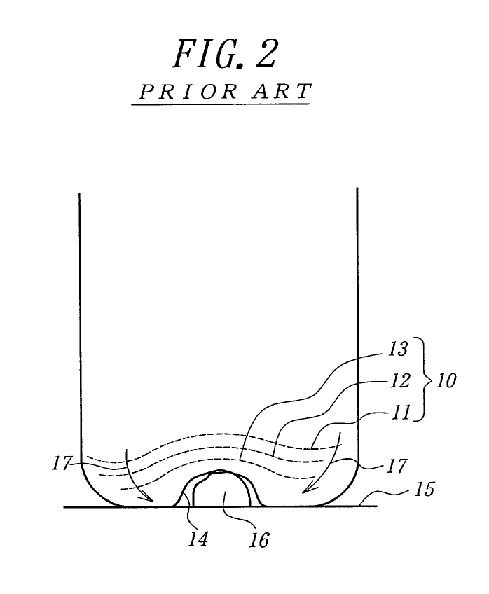

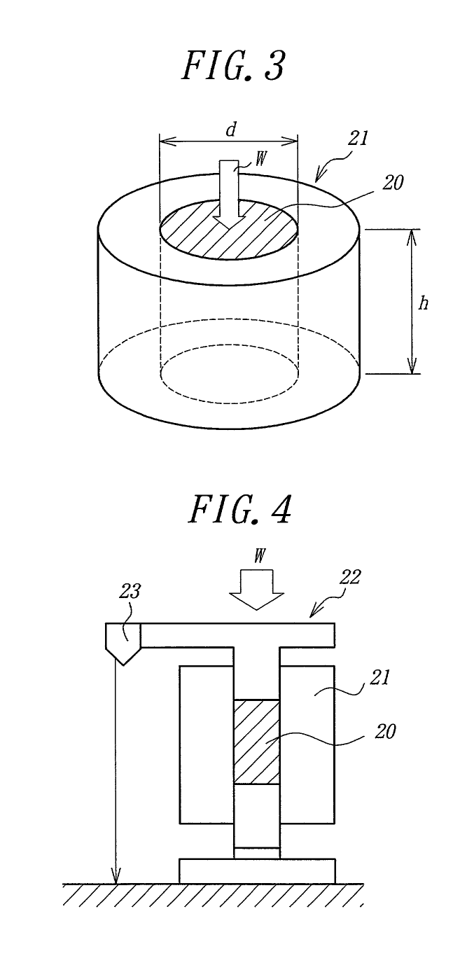

In the tread pattern of this tire 30 shown in FIG. 2, the central region of the tread portion 31 is provided with rows of blocks 44, 45, 46 defined by four circumferential grooves 39, 40 extending straightforward in the circumferential direction and a plurality of lateral grooves 41, 42, 43 extending between the mutual circumferential grooves 39, 39 and between the circumferential grooves 39 and 40 and opening to the respective circumferential grooves, which grooves being formed on the tread rubber 32, and each of both side regions of the tread portion is provided with a row of blocks 48 defined by the circumferential groove 40 and a plurality of lateral grooves 47 opening thereto.

Although the tread pattern shown in FIG. 2 is a block pattern of forming the blocks over a full region of the tread portion 31, the invention may take a rib pattern wherein ribs are formed over the full region of the tread portion only by plural circumferential grooves or a block-rib pattern of combining rib rows and block rows in the tread portion. Moreover, the circumferential grooves 39, 40 in the illustrated embodiment are straight grooves, but may be zigzag grooves.

In this embodiment, the outermost cord layer 37 has a width extending toward an end of the tread portion 31 over an outermost groove edge of an outermost circumferential groove among the circumferential grooves located in both side regions of the tread portion, the circumferential groove 40 in the illustrated embodiment in a widthwise direction of the tread portion. In the embodiment of FIG. 6, a width Lb₁ of the outermost cord layer 37 is larger than a distance Lg between planes P₁, P₂ parallel to the equatorial plane E passing through the outermost groove edges of the circumferential grooves 40 located at both side regions of the tread portion. In other words, the width end 37E of the outermost cord layer 37 always locates outward from the plane P₁, P₂ in the widthwise direction of the tire.

As previously mentioned, the cords 35a of the innermost cord layer 35 and the cords 36a of the middle cord layer 36 are arranged at the inclination angle (α, β) of 10-25°, preferably 15-22° with respect to the equatorial plane E, while the cords 37a of the outermost cord layer 37 are arranged at the inclination angle (γ) of 45-115°, preferably 50-100° with respect to the equatorial plane E as measured in the same direction as in the cord 36a of the middle cord layer 36, whereby circumferential tension created in the belt 34 of the tread portion 31 when the tire 30 is inflated under an inner pressure as shown by an arrow Fx in FIG. 6 is mainly born by the cords 35a and 36a of the innermost cord layer 35 and the middle cord layer 36 forming the cross cord layer 38 at a small inclination angle with respect to the equatorial plane E, so that tension to be born by the outermost cord layer 37 can largely be decreased.

Thus, when the tread portion 31 of the tire 30 during the running under loading rides on a foreign matter such as broken stone, small rock or the like having a sharp corner edge, even if the corner edge arrives at the belt 34 through the tread rubber 33, the cords 37a of the outermost cord layer 37 are hardly cut and the durability of the tire 30 is improved based on such a cut resistance.

And also, the belt 34 tends to project outward in the radial direction of the tire 30 by tension Fx created in the belt 34 when the tire 30 is inflated under the inner pressure and hence the belt 34 intends to contract inward in the widthwise direction thereof as a whole, so that the cords 35a, 36a and 37a of the cord layers 35, 36, 37 in the belt 34 are intended to change into a direction of decreasing the inclination angles α, β, γ, respectively. In the belt 34 having the above structure, however, the inclination angle γ of the cord 37a of the outermost cord layer 37 is considerably larger than those α, β of the cords 35a, 36a of the innermost cord layer 35 and the middle cord layer 36, so that the degree of decreasing the inclination angle in the cord 37a is very small as compared with those of the cords 35a, 36a and hence the outermost cord layer 37 indicates a tendency hardly causing the contraction in the widthwise direction.

This means that the outermost cord layer 37 acts to control the contraction of the cross cord layer 38 in the widthwise direction because the cords 37a of the outermost cord layer 37 acts as a prop to the cross cord layer 38. As a result, the cross cord layer 38 having the controlled widthwise contraction increases the circumferential rigidity of the tread portion 31, and hence the cornering power (hereinafter abbreviated as CP) can be improved even in the tire 30 having the belt 34 of the three-layer structure to develop the cornering performance equal to or more than that of the conventional tire having a belt of four-layer structure. Furthermore, the increase of the circumferential rigidity in the cross cord layer 38 largely contributes to control the growth of tire size in the inflation of the tire under the inner pressure.

Moreover, the inclination angles α, β of the cords 35a and 36a in the innermost cord layer 35 and the middle cord layer 36 are approximately equal to each other with respect to the equatorial plane E and the planes P₁, P₂ parallel to the equatorial plane from a viewpoint that tension is equally born by the cords 35a and 36a. The reason why the inclination angles α, β of the cords 35a and 36a are restricted to a range of 10-25° is due to the fact that when each of the inclination angles α, β is less than 10°, interlaminar shearing strain produced between the innermost cord layer 35 and an end portion of the middle cord layer 36 becomes too large and the separation failure is apt to be caused at such an end portion, while when the inclination angle α, β exceeds 25°, the effect of controlling the widthwise contraction of the outermost cord layer 37 can not sufficiently be developed due to the tension Fx acting to the belt 34 in the tire 30 inflated under the inner pressure and hence the circumferential rigidity of the cross cord layer 38 considerably lowers to bring about the degradation of CP property and the increase of tire size growth.

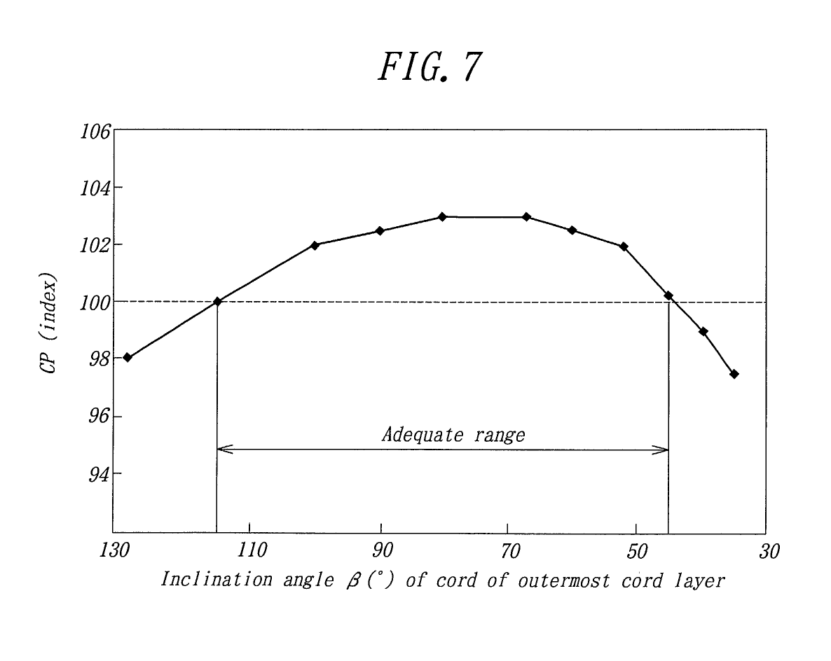

In FIG. 7 is shown a comparison of CP property between the tire 30 having the belt 34 and the conventional tire having the belt of four-layer structure. The CP property of the tire 30 is measured by changing the inclination angle γ of the cord 37a of the outermost cord layer 37 and represented by an index on the basis that the conventional tire is 100. As seen from FIG. 7, the adequate inclination angle γ indicating the index value of not less than 100 (i.e. CP property is equal to or more than that of the conventional tire) is within a range of 45-115°. When the inclination angle γ is less than 45° or exceeds 115°, the CP property is degraded as compared with that of the conventional tire, so that the inclination angle γ should be within the adequate range of 45-115°. From this fact, it is proved that the cords 37a of the outermost cord layer 37 act as a prop to the widthwise contraction of the cross cord layer 38 and enhance the circumferential rigidity of the cross cord layer 38.

And also, when the tire 30 is run on a road surface scattered with a relatively large foreign matter such as broken stones and rocks and rides on such a foreign matter, as previously mentioned on FIG. 2, the outermost cord layer 37 in the belt 34 is forcedly subjected to a bending deformation at a large curvature and hence a large compression force is locally applied to the outermost cord layer 37 to cause buckling in the cords 37a thereof. In the invention, however, rubber having a compression modulus of not less than 200 kgf/cm² is used as a coating rubber 37b for the cord 37a in the outermost cord layer 37, whereby the compression resistance of the coating rubber 37b is increased, so that it is possible to prevent the buckling deformation of the cord 37a in the outermost cord layer 37. As a result, even when the tire frequently rides on the relatively large foreign matter such as broken stone or rock, the occurrence of cord breakage due to the buckling fatigue of the cord 37a in the outermost cord layer 37 can be prevented. When the compression modulus of the coating rubber is less than 200 kgf/cm², the above effect is insufficient.

Furthermore, when the sharp corner edge of the foreign matter such as broken stone or rock scatted on the road surface bites into the bottom of the circumferential groove 39, 40 during the running of the tire, since the outermost cord layer 37 has a width extending toward the end of the tread portion 31 over the outermost groove edges of the outermost circumferential grooves 40 existing in both side regions of the tread in the widthwise direction, even if the corner edge of the foreign matter arrives at the belt 34 through the thin tread rubber 32 located beneath the groove bottom, many cords 37a of the outermost cord layer 37 are always existent beneath the thin tread rubber and indicate a sufficient resistance to cut input as mentioned below.

The reason why many cords 37a of the outermost cord layer 37 are existent ahead the corner edge of the foreign matter bitten into the circumferential groove 40 along the groove bottom thereof is due to the fact that when the circumferential groove 40 is a straight groove, an angle defined between the groove bottom and the cord 37a of the outermost cord layer 37 is not less than 45°. In this connection, if the circumferential groove 40 is a zigzag groove, the difference between inclination angle of the zigzag groove with respect to the plane P₁, P₂ parallel to the equatorial plane E and inclination angle of the cord 37a of the outermost cord layer 37 is favorably rendered into not less than 20°. If such an inclination angle difference is less than 20°, the number of the cords 27a receiving the entrance of the corner edge of the foreign matter becomes too small.

In any case, the cord 37a of the outermost cord layer 37 receiving the cut input of the sharp corner edge of the foreign matter is slight in the tension bearing ratio and has a sufficient energy against the cut, so that the entrance of the corner edge can be stopped by the outermost cord layer 37 to prevent the breakage of the cords 36a in the middle cord layer 36. For this end, the outermost cord layer 37 is required to have a width extending outward over the outermost groove edge of the outermost circumferential groove 40 in the widthwise direction of the tire. If the circumferential groove 40 is a zigzag groove, the outermost cord layer 37 is sufficient to have a width extending outward over a top of the groove edge at the outermost position of the mountain-shaped groove in the widthwise direction.

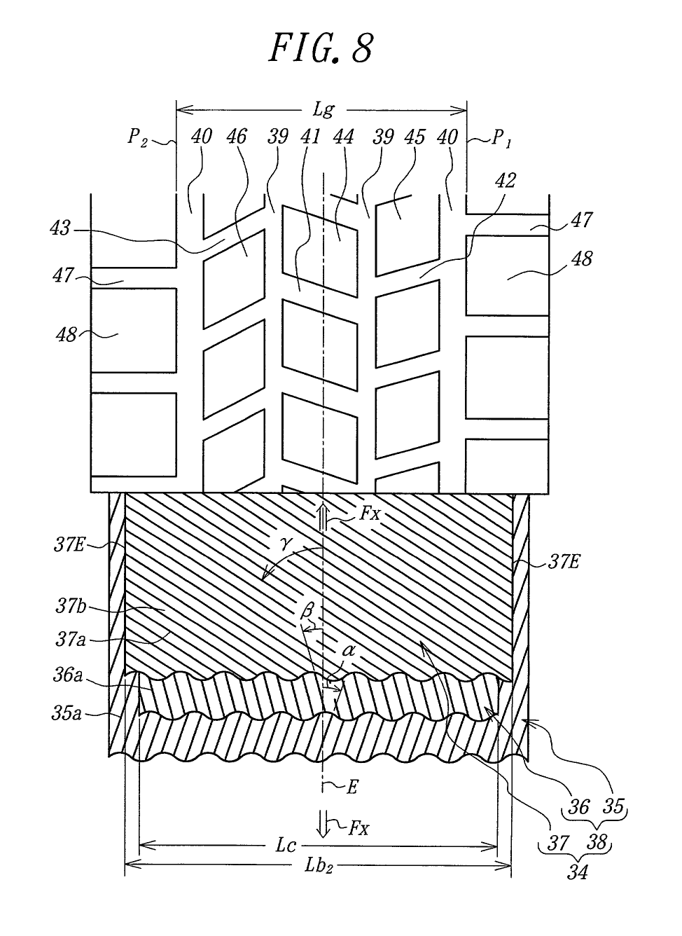

The width of the outermost cord layer 37 (developed width Lb₁) is enough to be narrower than a width of the middle cord layer 36 as shown in FIG. 6. In order to more ensure the cut resistance and further improve separation resistance between end portion of the innermost cord layer 35 forming the end portion of the cross cord layer 38 and the middle cord layer 36, as shown in FIG. 8, the width of the outermost cord layer 37 (developed width Lb₂) in the belt 34 is made wider than the width of the middle cord layer 36 (developed width Lc) so as to cover both widthwise ends of the middle cord layer 37 with the outermost cord layer 37.

In the end zone of the middle cord layer 37 shown in FIGS. 5 and 6, only the cross cord layer 38 is subjected to shearing deformation and hence shearing strain concentrates between the end portion of the middle cord layer 36 and the innermost cord layer 35 just beneath the tread portion 31 of the tire 30 under loading and the separation failure is apt to be caused in the cross cord layer 38 at the end zone of the middle cord layer 36.

On the contrary, when the width of the outermost cord layer 37 is made wider than the width of the middle cord layer 36 as shown in FIG. 8, a part of the shearing rigidity of the cross cord layer 38 is taken over between the end portion of the middle cord layer 36 and the end portion of the outermost cord layer 37 at the end zone of the middle cord layer 36, so that the interlaminar shearing strain in the cross cord layer 38 at the end zone of the middle cord layer 36 is decreased and the occurrence of the separation failure is more prevented.

In the tire shown in FIG. 8, the width of the outermost cord layer 37 is favorable to be within a range of 1.0-1.2 times the width of the middle cord layer 36. As the width of the outermost cord layer 37 becomes wider, tensile strain at the end portion of the outermost cord layer 37 just beneath the tire under loading in the rotating axial direction of the tire increases, and if the width of the outermost cord layer 37 exceeds 1.2 times the width of the middle cord layer 36, the tensile strain at the end portion of the outermost cord layer 37 becomes excessively large and hence the separation failure is apt to be caused at the end of the outermost cord layer 37.

On the other hand, when the width of the outermost cord layer 37 is within a range of 1.0-1.2 times the width of the middle cord layer 36, the shearing strain between the end portion of the middle cord layer 36 and the outermost cord layer 37 naturally increases as compared with the case that the width of the outermost cord layer 37 is less than the width of the middle cord layer 36. For this end, it is advantageous to control such an interlaminar sharing strain to not more than interlaminar sharing strain of the cross cord layer 38, so that a rubber gauge between the cord at the end portion of the middle cord layer 36 and the cord of the outermost cord layer 37 adjacent to such a cord of the middle cord layer is made to be not less than 0.15 times a rubber gauge between the cord at the end portion of the middle cord layer 36 and the cord of the innermost cord layer 35 adjacent to such a cord of the middle cord layer. When the rubber gauge is less than 0.15 times, the shearing strain between the end portion of the middle cord layer 36 and the outermost cord layer becomes too large and the separation failure is apt to be caused between such cord layers.

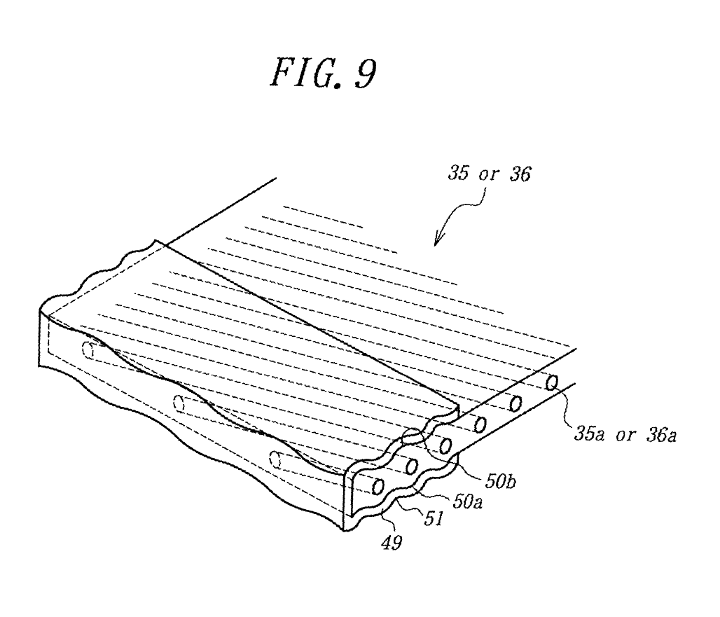

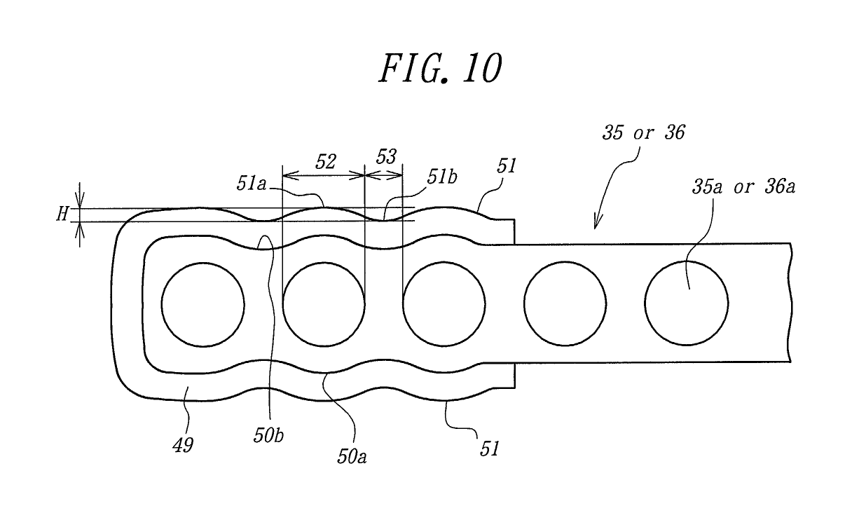

In order to satisfy the relation of the above rubber gauge between the cords and mitigate the interlaminar shearing stress of the cross cord layer 38, as shown in FIGS. 9 and 10, a sheet-shaped end cover rubber 49 is arranged in a widthwise end portion of at least one of the innermost cord layer 35 and the middle cord layer 36 so as to cover the end portion of the cord layer. At least one surface of inner surface 50a and outer surface 50b in the radial direction of the tire at the end portion of the innermost cord layer 35 or the middle cord layer 36 provided with the end cover rubber 49, the inner and outer surfaces 50a, 50b in the illustrated embodiment are a wavy surface forming a mountain part at a cord existing position (35a, 36a) and a valley part at a position between adjoining cords (35a, 36a) of the layer. As a result, the surface 51 of the end cover rubber 49 has a wavy surface consisting of mountain parts 51a and valley parts 51b. The mountain part 51a corresponds to the cord existing position 52 (35a, 36a) and the valley part 51b corresponds to the position 53 between the adjoining cords (35a, 36a). A difference of height H between the mountain part 51a and the valley part 51b is within a range of 0.05-0.25 mm. Such a height difference H largely contributes to control the occurrence of separation between the innermost cord layer 35 and the end portion of the middle cord layer 36 constituting the cross cord layer 38.

The reason why the height difference H between the mountain part 51a and the valley part 51b in the end cover rubber 49 is restricted to a range of 0.05-0.25 mm is due to the fact that when the height difference H is less than 0.05 mm, the effect of controlling the occurrence of separation at the end portion of the cross cord layer 38 is not obtained in practice, while when it exceeds 0.25 mm, a greater amount of air is enveloped in recess portions corresponding to valley parts 51b of the tire 30 during the laying of cord layer members for the belt in the building of an uncured tire and a portion enveloping air is not adhered in the vulcanization building of the uncured tire and hence separation is caused from such a portion.

The wavy form on the inner surface 50a and the outer surface 50b of the innermost cord layer 35 or the middle cord layer 36 and the surface 51 of the end cover rubber 49 is carried out by a method wherein at least one surface of at least an end portion of an uncured rubberized cord layer member cut into a given length is pushed by the same roll as comb roll aligning steel cords in a given arranging direction when a continuous cord layer member corresponding to cord layers 35, 36 for the cross cord layer 38 of the belt 34 is manufactured by calendar rolls, or by thinning rubber gauge of uncured coating rubber for the cords 35a, 36a. In the latter case, the rubber gauge is set considering the fact that if the rubber gauge of the coating rubber is too thin, the cords 35a, 36a are easily exposed at the production stage of uncured members.

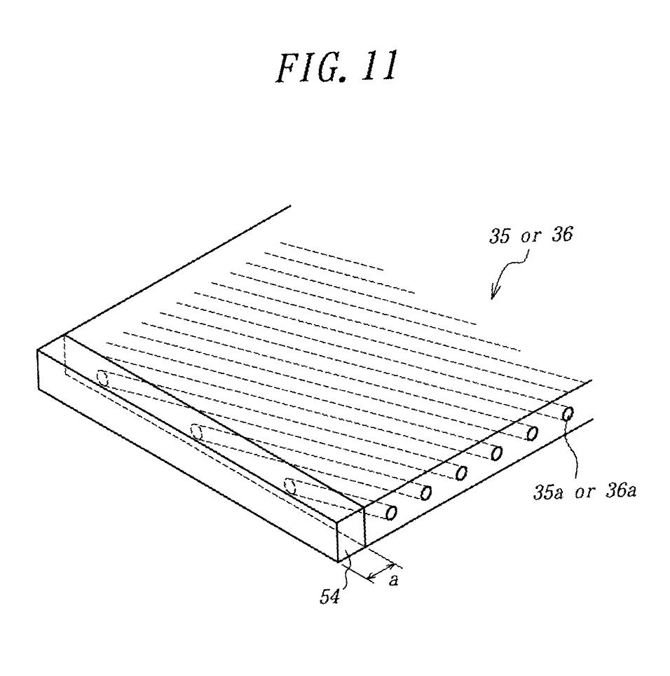

As shown in FIG. 11, a rubber layer 54 is joined to a widthwise end face of at least one of the innermost cord layer 35 and the middle cord layer 36 over a full periphery of the cord layer instead of the end cover rubber 49. The rubber layer 54 can prevent the projection of ends of the cords 35a, 36a of the innermost cord layer 35 and the middle cord layer 36 into the tread rubber 32 and contributes to improve the separation resistance at the end portion of the cross cord layer 38. In this case, the width a of the rubber layer 54 is within a range of 0.05-5.00 mm.

When the width a of the rubber layer 54 is less than 0.05 mm, the effect of controlling the occurrence of separation failure becomes too small, while when the width a exceeds 5.00 mm, if the uncured cord layer members for the innermost cord layer 35 and the middle cord layer 36 are fed onto a building drum from their feeding devices in the building of the uncured tire, the uncured rubber member for the rubber layer 54 hangs down or turn up and there is caused a problem of damaging the operability.

In case of arranging the rubber layer 54, the end cover rubber 49 may not be arranged, but the rubber layer 54 and the end cover rubber 49 may be used together. In the latter case, the surface 51 of the end cover rubber 49 is not necessarily rendered into the wavy surface 51a, 51b. Moreover, the rubber layer 54 is favorable to have the same rubber composition as coating rubbers for the cord in the innermost cord layer 35 and the cord in the middle cord layer 36 from a viewpoint of the productivity. Thus, the ends of the cords 35a of the innermost cord layer 35 and the cords 36a of the middle cord layer 36 can be protected by the rubber layer 54 having the same rubber composition, which is advantageous in the improvement of the separation resistance. And also, the end cover rubber 49 is favorable to have a 100% modulus larger than that of the cord coating rubber.

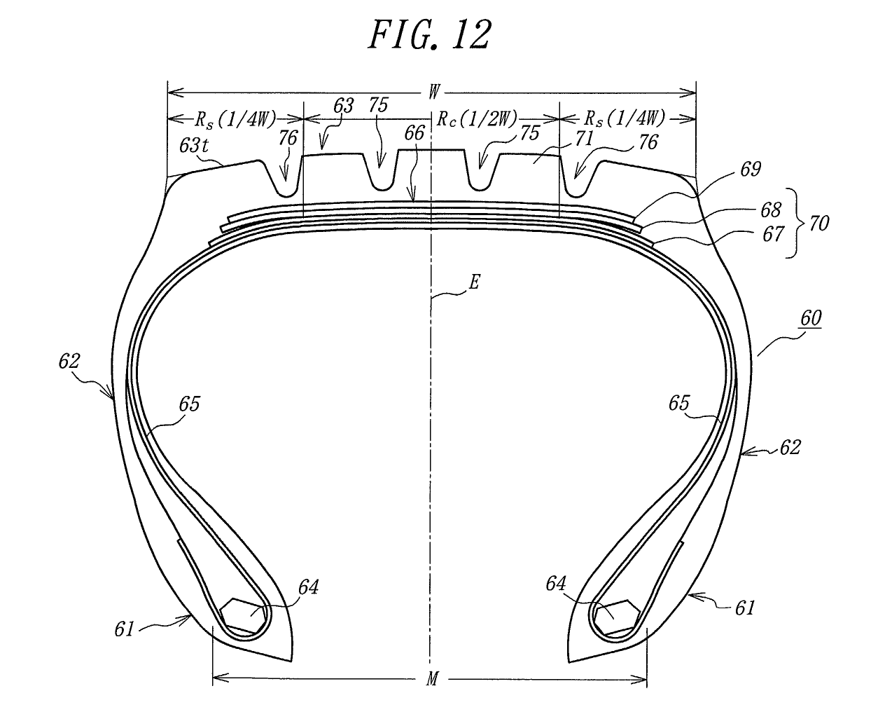

In FIG. 12 is shown a second embodiment of the pneumatic radial tire according to the invention. This tire 60 comprises a pair of bead portions 61, a pair of sidewall portions 62 and a tread portion 63 connecting to both sidewall portions 62 to each other. And also, the tire 60 comprises a radial carcass 65 extending between a pair of bead cores 64 embedded in the bead portions 61 to reinforce the pair of the bead portions 61 and the pair of the sidewall portions 62 and the tread portion 63 and comprised of one or more rubberized steel cord plies, one cord ply in the illustrated embodiment and a belt 66 arranged on an outer circumference of the carcass 65 to reinforce the tread portion 63.

The belt 66 is comprised of three rubberized steel cord layers 67, 68, 69, wherein innermost cord layer 67 and middle cord layer 68 form a cross cord layer 70. Further, the tire 60 has a tread rubber 71 in the tread portion 63 located on an outer peripheral side of an outermost cord layer 69, and at least a central region Rc of the tread rubber 71 in the tread portion 63 is provided with at least two circumferential grooves extending in the circumferential direction of the tread portion 63 as a pair. The tread portion 63 of the illustrated embodiment is provided on its central region Rc with two circumferential grooves 75 (hereinafter referred to as circumferential center groove 75) and on each of both side regions Rs with one circumferential groove 76 (hereinafter referred to as circumferential shoulder groove 76).

The central region Rc is a region corresponding to ½ of a width W of a tread surface 63t of the tread portion 63, which is two equal parts sandwiching an equatorial plane E of the tire when the width W of the tread surface is divided into four equal parts or 1/4W parts, and each of both side regions Rs is a region corresponding to 1/4W part. When the end portion of the tread portion 63 is a round shoulder, as shown in FIG. 12, the width W is a distance between intersect points each being an intersect between an extended line of the tread surface 63t and an extended line of buttress. Moreover, the circumferential center groove 65 and circumferential shoulder groove 66 may be straight groove, straight groove having see-through protrusions therein, curved groove having arcs on both groove edges wherein the arc has a large radius of curvature and centers of the radii of curvature of the arcs are alternately changed into inside and outside of the groove in the widthwise direction of the tread surface 63t, or a zigzag groove having a relatively small amplitude.

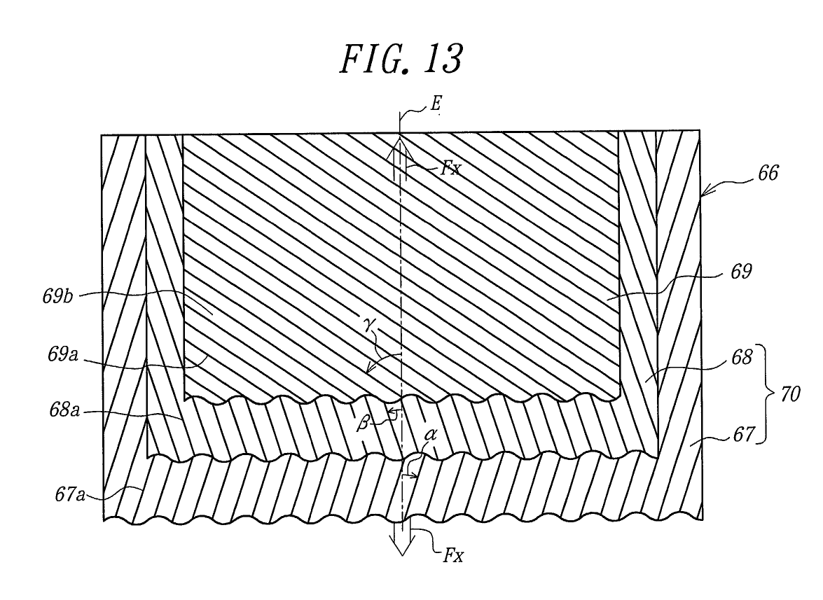

As shown in FIG. 13, cords 67a of the innermost cord layer 67 nearest to the carcass 65 and cords 68a of the middle cord layer 68 are arranged so as to cross with each other with respect to the equatorial plane E of the tire. The inclination angles α, β of the cord 67a of the innermost cord layer 67 and the cord 68a of the middle cord layer 68 with respect to the equatorial plane E of the tire are within a range of 10-25°, preferably 15-22°, respectively. On the other hand, the cords 69a of the outermost cord layer 69 have an inclination angle γ of 45-115°, preferably 50-100° with respect to the equatorial plane E as measured in the same direction as the cords 68a of the middle cord layer 68.

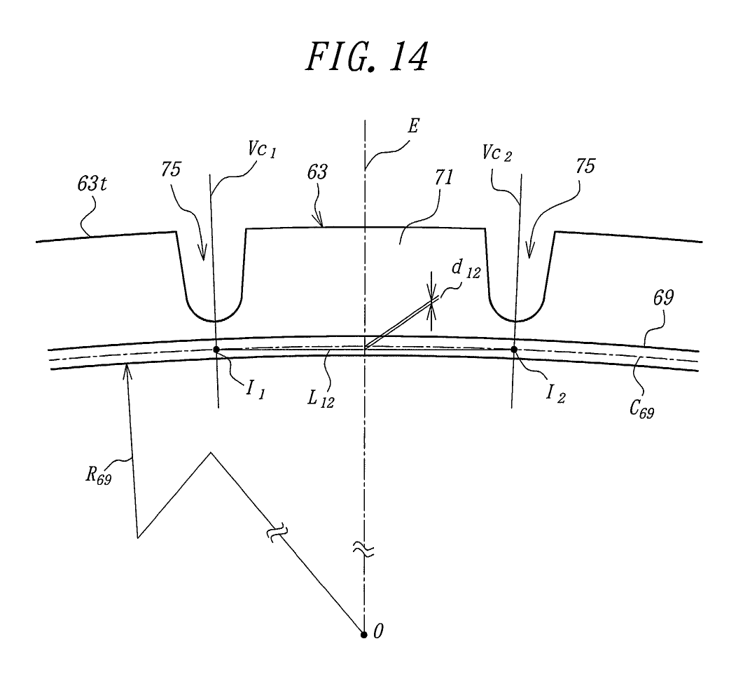

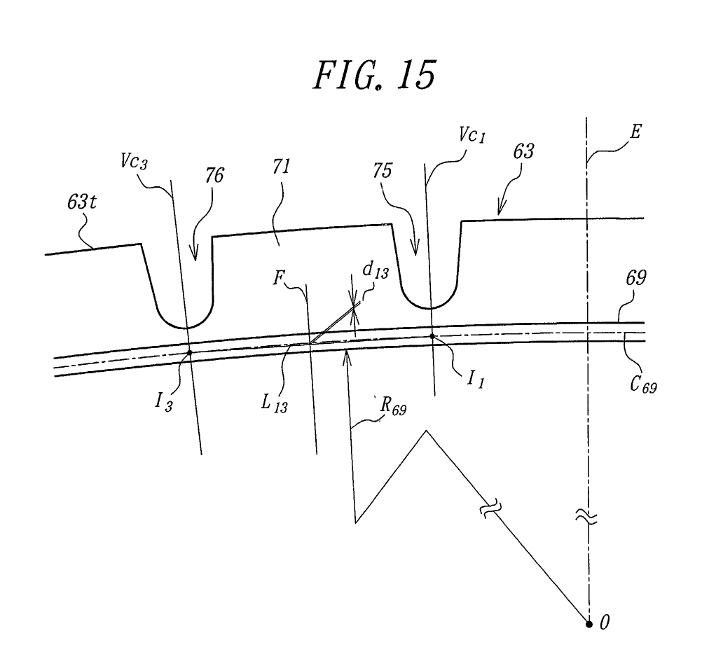

In FIGS. 14 and 15 is shown at least one cord layer of the middle cord layer 68 and the outermost cord layer 69 (only the outermost cord layer 69 in the illustrated embodiment). In this case, a cord layer line C₆₉ passing through a center of a thickness of the outermost cord layer 69 is comprised of a curved line or a composite of curved line and straight line. The cord layer line C₆₉ shown in FIGS. 14 and 15 is a curved line, which is an arc having a radius of curvature R₆₉. In the cord layer line C₆₉, a center o of the radius of curvature is existent inside the tire over a full width of the outermost cord layer 69.

The middle cord layer 68 may have the same cord layer line C₆₈ (not shown) as the cord layer line C₆₉. Moreover, when the cord layer line C₆₉ (including the line C₆₈) is a composite of curved line and straight line, a portion of the straight line locates just beneath each of the circumferential center groove 65 and the circumferential shoulder groove 66.

At a section of the tire fitting an outer width M of the bead portion 61 as shown in FIG. 12 to an approved rim of such a tire, as shown in FIG. 14, a line segment L₁₂ connecting two intersects I₁, I₂ of lines V_{C1}, V_{C2} equally dividing a groove width of the circumferential center groove 65 to the cord layer line C₆₉ is existent inside the cord layer line C₆₉ in the radial direction of the tire or is consistent therewith. A maximum distance d₁₂ between the line segment L₁₂ and the cord layer line C₆₉ is not more than 1.0 mm, desirably not more than 0.7 mm. A position of a line indicating the maximum distance d₁₂ is substantially consistent with a middle position between the pair of the circumferential center grooves 75 or the equatorial plane E.

Similarly, when the tread portion 63 is provided with a pair of circumferential center groove 75 and circumferential shoulder groove 76 as shown in FIG. 15, a line segment L₁₃ connecting an intersect 13 between a line V_{C3} equally dividing a groove width of the circumferential shoulder groove 76 and the cord layer line C₆₉ to the intersect I₁ is existent inside the cord layer line C₆₉ in the radial direction of the tire or is consistent therewith. A maximum distance d₁₃ between the line segment L₁₃ and the cord layer line C₆₉ is not more than 1 mm, desirably not more than 0.7 mm. A position of a line F indicating the maximum distance d₁₃ is substantially consistent with a middle position between the circumferential center groove 75 and the circumferential shoulder groove 76.

When the maximum distance d exceeds 1.0 mm, the peeling operation of the outermost cord layer 69 is unfavorably degraded in the recapping. The lower limit of the maximum distance d is zero. Although only the radius of curvature R₆₉ is shown as a radius of curvature in the cord layer line C₆₉, plural radii of curvature may be existent in the cord layer line C₆₉. Moreover, the above is true in the middle cord layer 68.

As previously mentioned, the cords 67a of the innermost cord layer 67 and the cords 68a of the middle cord layer 68 are arranged at the inclination angle (α, β) of 10-25°, preferably 15-22° with respect to the equatorial plane E, while the cords 69a of the outermost cord layer 69 are arranged at the inclination angle (γ) of 45-115°, preferably 50-100° with respect to the equatorial plane E as measured in the same direction as in the cord 68a of the middle cord layer 68, whereby circumferential tension created in the belt 66 of the tread portion 63 when the tire 60 is inflated under an inner pressure as shown by an arrow Fx in FIG. 13 is mainly born by the cords 67a and 68a of the innermost cord layer 67 and the middle cord layer 68 forming the cross cord layer 70 at a small inclination angle with respect to the equatorial plane E, so that tension to be born by the outermost cord layer 69 can largely be decreased.

Thus, when the tread portion 63 of the tire 60 during the running under loading rides on a foreign matter such as broken stone, small rock or the like having a sharp corner edge, even if the corner edge arrives at the belt 66 through the tread rubber 71, the cords 69a of the outermost cord layer 69 are less in the tension bearing and have an energy enough to counter to the cut, so that they are hardly cut and hence the ability of stopping the entrance of the corner edge of the foreign matter by the outermost cord layer 69 becomes considerably higher and the cutting of the cords 68a in the middle cord layer 68 hardly occurs and consequently the durability of the tire 60 is improved based on such a cut resistance.

And also, the belt 66 tends to project outward in the radial direction of the tire 60 by tension Fx created in the belt 66 when the tire 60 is inflated under the inner pressure and hence the belt 66 intends to contract inward in the widthwise direction thereof as a whole, so that the cords 67a, 68a and 69a of the cord layers 67, 68, 69 in the belt 66 are intended to change into a direction of decreasing the inclination angles α, β, γ, respectively. In the belt 66 having the above structure, however, the inclination angle γ of the cord 69a of the outermost cord layer 69 is considerably larger than those α, β of the cords 67a, 68a of the innermost cord layer 67 and the middle cord layer 68, so that the degree of decreasing the inclination angle in the cord 69a is very small as compared with those of the cords 67a, 68a and hence the outermost cord layer 69 indicates a tendency hardly causing the contraction in the widthwise direction.

This means that the outermost cord layer 69 acts to control the contraction of the cross cord layer 70 in the widthwise direction because the cords 69a of the outermost cord layer 69 acts as a prop to the cross cord layer 70. As a result, the cross cord layer 70 having the controlled widthwise contraction increases the circumferential rigidity of the tread portion 63, and hence the cornering power (CP) can be improved even in the tire 60 having the belt 66 of the three-layer structure to develop the cornering performance equal to or more than that of the conventional tire having a belt of four-layer structure. Furthermore, the increase of the circumferential rigidity in the cross cord layer 70 largely contributes to control the growth of tire size in the inflation of the tire under the inner pressure, which largely contributes to improve the separation resistance at the end portion of the belt 66, particularly the end portion of the cross cord layer 70.

Moreover, the inclination angles α, β of the cords 67a and 68a in the innermost cord layer 67 and the middle cord layer 68 are approximately equal to each other with respect to the equatorial plane E from a viewpoint that tension is equally born by the cords 67a and 68a. The reason why the inclination angles α, β of the cords 67a and 68a are restricted to a range of 10-25° is due to the fact that when each of the inclination angles α, β is less than 10°, interlaminar shearing strain produced between the innermost cord layer 67 and an end portion of the middle cord layer 68 becomes too large and the separation failure is apt to be caused at such an end portion, while when the inclination angle α, β exceeds 25°, the effect of controlling the widthwise contraction of the outermost cord layer 69 can not sufficiently be developed due to the tension Fx acting to the belt 66 in the tire 60 inflated under the inner pressure and hence the circumferential rigidity of the cross cord layer 70 considerably lowers to bring about the degradation of CP property and the increase of tire size growth.

Even in this tire 60, as shown in FIG. 7, the adequate inclination angle γ indicating the index value of not less than 100 (i.e. CP property is equal to or more than that of the conventional tire) is within a range of 45-115°. When the inclination angle γ is less than 45° or exceeds 115°, the CP property is degraded as compared with that of the conventional tire, so that the inclination angle γ should be within the adequate range of 45-115°. From this fact, it is proved that the cords 69a of the outermost cord layer 69 act as a prop to the widthwise contraction of the cross cord layer 70 and enhance the circumferential rigidity of the cross cord layer 70.

Furthermore, when the section shape of at least the outermost cord layer 69 is set so that the curved lien or the composite of curved line and straight line in the cord layer line C₆₉ of the outermost cord layer 69 (see FIGS. 14 and 15) including the cord layer line C₆₈ of the middle cord layer 68 has a center O of the radius of curvature inside the tire over the full width of the outermost cord layer 69, the peeling of the outermost cord layer 69 subjected to cut damage is very easy in the recapping after the use of the tire and the recapping operation is largely improved.

The above cord layer line C₆₈, C₆₉ can be attained by restricting the inclination angle γ of the cord 69a of the outermost cord layer 69 to a range of 45-115° with respect to the equatorial plane. Because, when the top of the mold rib for the formation of the circumferential groove 75, 76 bites into an uncured tread rubber in a tread portion of an uncured tire under the action of high pressure gas filled in the inside of the uncured tire during the vulcanization building of the uncured tire, the uncured cord layer as the outermost cord layer 69 increases the bending rigidity in the widthwise direction because the inclination angle is an angle near to a range of 45-115° and hence the bending resistance of the laminate as the belt is increased against the entrance of the top of the mold rib.

Moreover, in the formation of the uncured tire, the uncured tread rubber having grooves previously formed at positions corresponding to the mold ribs for the formation of the circumferential center grooves 75 and circumferential shoulder grooves 76 is used to decrease pushing force of the mold ribs against the uncured cord layers constituting the belt 66, or a ratio of outer periphery (outer diameter) of the uncured cord layer in the uncured tire to outer periphery (outer diameter) of the outermost cord layer 69 in the cured tire is approached to 1 as far as possible, whereby the change of peripheral length of the uncured cord layer in the vulcanization building can be controlled to a minimum to make the cord layer line C₆₈, C₆₉ more sufficient. In addition, the end count of each cord layer in the belt is rendered into not less than 18 cords/50 mm, whereby the cords are densely arranged in each of the cord layers, which also contributes to the construction of the cord layer line.

A coating rubber 69b for the cord 69a of the outermost cord layer 69 has a compression modulus of not less than 200 kgf/cm² likewise the aforementioned first embodiment. In this case, the uncured rubber for rubber having a compression modulus of not less than 200 kgf/cm² is high in minimum value of Mooney viscosity, so that it contributes to increase the bending rigidity of the laminate of uncured cord layers for the belt 66 against the mold rib in the vulcanization building of the uncured tire.

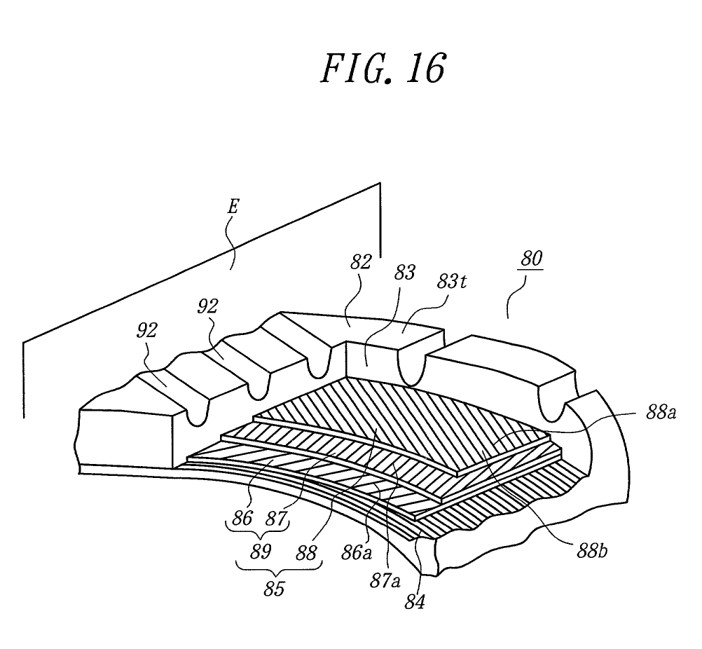

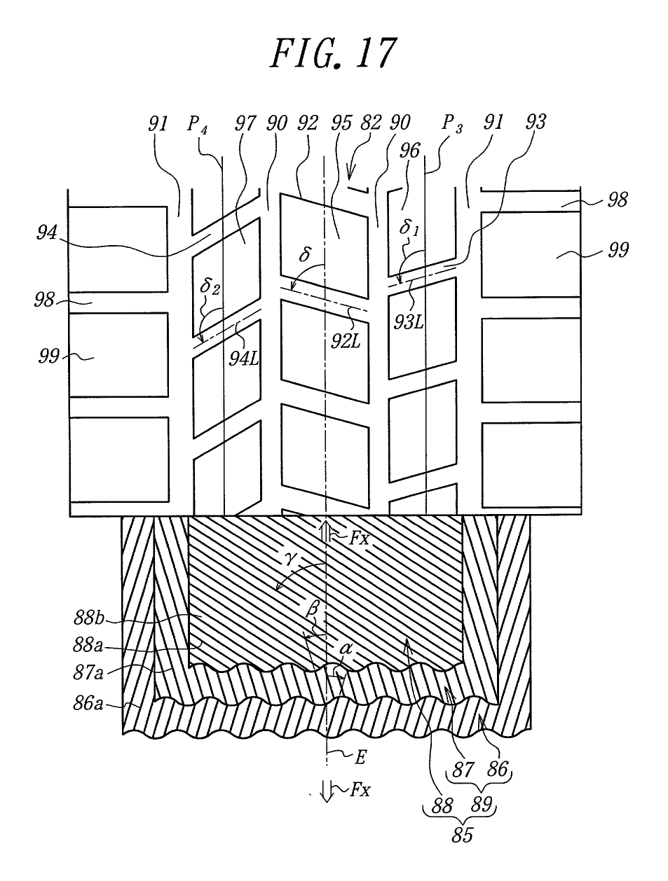

In FIGS. 16 and 17 is shown a third embodiment of the pneumatic radial tire according to the invention. This tire 80 comprises a pair of bead portions (not shown), a pair of sidewall portions (not shown) and a tread portion 82 connecting to both sidewall portions to each other. And also, the tire 80 comprises a radial carcass 84 extending between a pair of bead cores (not shown) embedded in the bead portions to reinforce the pair of the bead portions, the pair of the sidewall portions and the tread portion 82 and comprised of one or more rubberized cord plies, one cord ply in the illustrated embodiment and a belt 85 arranged on an outer circumference of the carcass 84 to reinforce the tread portion 82.

Referring to FIGS. 16 and 17, the belt 85 is comprised of three rubberized steel cord layers 86, 87, 88, wherein cords 86a and 87a of innermost cord layer 86 located nearest to the carcass 84 and middle cord layer 87 are arranged so as to be crossed with each other with respect to an equatorial plane E of the tire to thereby form a cross cord layer 89. In this case, inclination angles α, β of the cords 86a and 87a in the innermost cord layer 86 and the middle cord layer 87 are within a range of 10-25°, preferably 15-22° with respect to the equatorial plane, respectively. On the other hand, cords 88a of an outermost cord layer 88 are arranged at an inclination angle γ of 45-115°, preferably 50-100° with respect to the equatorial plane E as measured in the same direction as the inclination angle β of the cord 87a of the middle cord layer 87. And also, the cord 88a in the outermost cord layer 88 is covered with a coating rubber 88b having a compression modulus of not less than 200 kgf/cm².

In the tread pattern of this tire 80 shown in FIG. 17, the central region of the tread portion 82 and a region located in the vicinity thereof are provided with rows of blocks 95, 96, 97 defined by four circumferential grooves 90, 91 extending straightforward in the circumferential direction and a plurality of lateral grooves 92, 93, 94 extending between the mutual circumferential grooves 90, 90 and between the circumferential grooves 90 and 91 and opening to the respective circumferential grooves, which grooves being formed on the tread rubber 83, and each of both side regions of the tread portion is provided with a row of blocks 99 defined by the circumferential groove 91 and a plurality of lateral grooves 99 opening thereto.

Although the tread pattern shown in FIG. 17 is a block pattern of forming the blocks over a full region of the tread portion 82, the invention may take a pattern that the rows of the blocks defined by the circumferential grooves and the lateral grooves are provided on at least the central region of the tread portion and another land portion such as rib or the like is formed in each of both side regions.

As to the lateral grooves 92 defining the blocks 95 of a central row in the tread portion 82 in the circumferential direction, an inclination angle δ of a center line 92L of a groove width of the lateral groove 92 with respect to the equatorial plane E has an inclination angle difference of not less than 20° with respect to an axial line of the cord 88a in the outermost cord layer 88 having the above inclination angle γ with respect to the equatorial plane.

Similarly, as to the lateral grooves 93, 94 defining the blocks 96, 97 of block rows located on both sides of the central row in the circumferential direction, inclination angles δ₁, δ₂ of center lines 93L, 94L of groove widths of the lateral grooves 93, 94 with respect to planes P₃, P₄ parallel to the equatorial plane E have an inclination angle difference of not less than 20° with respect to the axial line of the cord 98a in the outermost cord layer 98 having the above inclination angle γ with respect to the equatorial plane, respectively. Such a relation of the inclination angle difference is applied to the lateral grooves 98 defining the blocks 99 of a block row located at each of both side regions of the tread portion 82 in the circumferential direction.

In this case, the feature that the inclination angles δ, δ₁, δ₂ have the inclination angle difference of not less than 20° with respect to the axial line of the cord 88a of the outermost cord layer 88 means that when γ>δ, γ>δ₁ and γ>δ₂ are existent as regards the inclination angle γ of the cord 88a, there are γ−δ≧20°, γ₁≧20° and γ−δ₂≧20°, and when γ<δ, γ<δ₁ and γ<δ₂ are existent, there are δ−γ≧20°, δ₁−δ≧20° and δ₂−γ≧20°.

As previously mentioned, the cords 86a of the innermost cord layer 86 and the cords 87a of the middle cord layer 87 are arranged at the inclination angle (α, β) of 10-25°, preferably 15-22° with respect to the equatorial plane E, while the cords 89a of the outermost cord layer 89 are arranged at the inclination angle (γ) of 45-115°, preferably 50-100° with respect to the equatorial plane E as measured in the same direction as in the cord 88a of the middle cord layer 88, whereby circumferential tension created in the belt 85 of the tread portion 82 when the tire 80 is inflated under an inner pressure as shown by an arrow Fx in FIG. 17 is mainly born by the cords 86a and 87a of the innermost cord layer 86 and the middle cord layer 87 forming the cross cord layer 89 at a small inclination angle with respect to the equatorial plane E, so that tension to be born by the outermost cord layer 88 can largely be decreased.

Thus, when the tread portion 82 of the tire 80 during the running under loading rides on a foreign matter such as broken stone, small rock or the like having a sharp corner edge, even if the corner edge arrives at the belt 85 through the tread rubber 83, the cords 88a of the outermost cord layer 88 are hardly cut and the durability of the tire 80 is improved based on such a cut resistance.

And also, the belt 85 tends to project outward in the radial direction of the tire 80 by tension Fx created in the belt 85 when the tire 80 is inflated under the inner pressure and hence the belt 85 intends to contract inward in the widthwise direction thereof as a whole, so that the cords 86a, 87a and 88a of the cord layers 86, 87, 88 in the belt 85 are intended to change into a direction of decreasing the inclination angles α, β, γ, respectively. In the belt 85 having the above structure, however, the inclination angle γ of the cord 88a of the outermost cord layer 88 is considerably larger than those α, β of the cords 86a, 87a of the innermost cord layer 86 and the middle cord layer 87, so that the degree of decreasing the inclination angle in the cord 88a is very small as compared with those of the cords 86a, 87a and hence the outermost cord layer 88 indicates a tendency hardly causing the contraction in the widthwise direction.

This means that the outermost cord layer 88 acts to control the contraction of the cross cord layer 89 in the widthwise direction because the cords 88a of the outermost cord layer 88 acts as a prop to the cross cord layer 89. As a result, the cross cord layer 89 having the controlled widthwise contraction increases the circumferential rigidity of the tread portion 82, and hence the cornering power (CP) can be improved even in the tire 80 having the belt 85 of the three-layer structure to develop the cornering performance equal to or more than that of the conventional tire having a belt of four-layer structure. Furthermore, the increase of the circumferential rigidity in the cross cord layer 89 largely contributes to control the growth of tire size in the inflation of the tire under the inner pressure, which largely contributes to the improvement of the separation resistance at the end portion of the belt 85, particularly the end portion of the cross cord layer 89.

Moreover, the inclination angles α, β of the cords 86a and 87a in the innermost cord layer 86 and the middle cord layer 87 are approximately equal to each other with respect to the equatorial plane E from a viewpoint that tension is equally born by the cords 86a and 87a. The reason why the inclination angles α, β of the cords 86a and 87a are restricted to a range of 10-25° is due to the fact that when each of the inclination angles α, β is less than 10°, interlaminar shearing strain produced between the innermost cord layer 86 and an end portion of the middle cord layer 87 becomes too large and the separation failure is apt to be caused at such an end portion, while when the inclination angle α, β exceeds 25°, the effect of controlling the widthwise contraction of the outermost cord layer 88 can not sufficiently be developed due to the tension Fx acting to the belt 85 in the tire 80 inflated under the inner pressure and hence the circumferential rigidity of the cross cord layer 89 considerably lowers to bring about the degradation of CP property and the increase of tire size growth.

Even in this tire 80, as shown in FIG. 7, the adequate inclination angle γ indicating the index value of not less than 100 (i.e. CP property is equal to or more than that of the conventional tire) is within a range of 45-115°. When the inclination angle γ is less than 45° or exceeds 115°, the CP property is degraded as compared with that of the conventional tire, so that the inclination angle γ should be within the adequate range of 45-115°. From this fact, it is proved that the cords 88a of the outermost cord layer 88 act as a prop to the widthwise contraction of the cross cord layer 89 and enhance the circumferential rigidity of the cross cord layer 89.

And also, when the tire 80 is run on a road surface scattered with a relatively large foreign matter such as broken stones and rocks and rides on such a foreign matter, as previously mentioned on FIG. 2, the outermost cord layer 88 in the belt 85 is forcedly subjected to a bending deformation at a large curvature and hence a large compression force is locally applied to the outermost cord layer 88 to cause buckling in the cords 88a thereof. In the invention, however, rubber having a compression modulus of not less than 200 kgf/cm² is used as a coating rubber 88b for the cord 88a in the outermost cord layer 88, whereby the compression resistance of the coating rubber 88b is increased, so that it is possible to prevent the buckling deformation of the cord 88a in the outermost cord layer 88. As a result, even when the tire 80 frequently rides on the relatively large foreign matter such as broken stone or rock, the occurrence of cord breakage due to the buckling fatigue of the cord 88a in the outermost cord layer 88 can be prevented. When the compression modulus of the coating rubber is less than 200 kgf/cm², the above effect is insufficient.

Furthermore, when the sharp corner edge of the foreign matter such as broken stone or rock scatted on the road surface bites into the bottom of the lateral grooves 92, 93, 94 so as to extend the longitudinal direction of the corner edge along the lateral grooves 92, 93, 94 during the running of the tire, if the extending directions of the lateral grooves 92, 93, 94 are consistent with the extending direction of the cord 88a of the outermost cord layer 88 or slightly differ therefrom, the corner edge of the foreign matter arrives at the outermost cord layer 88 in the belt 85 through the thin tread rubber 83 located just beneath the bottoms of these grooves and further easily passes through the outermost cord layer 88 to cut the cords 87a of the middle cord layer 87 bearing a large tension and having a less energy against cut input. Because, the cord 88a to be durable to the cut input is hardly existent in the outermost cord layer 88 or the number of the cords 88a is very little.

On the contrary, when the inclination angles δ, δ₁, δ₂ of the lines 92L, 93L, 94L passing through groove centers of the lateral grooves 92, 93, 94 with respect to the equatorial plane E and planes P₃, P₄ parallel thereto are made to have an inclination angle difference of not less than 20° with respect to the axial line of the cord 88a of the outermost cord layer 88, even if the sharp corner edge of the foreign matter enters along the bottoms of the lateral grooves 92, 93, 94 and cuts the tread rubber 83 at the groove bottoms to arrive at the outermost cord layer 88, many cords 88a of the outermost cord layer 88 are existent at the corner edge entered place and have an energy enough to counter the cut input because the cords 88a are slight in the tension bearing ratio and hence the entrance of the corner edge can be stopped by the outermost cord layer 88 and the breakage of the cord 87a of the middle cord layer 87 can be prevented.

As mentioned above, the lines 92L, 93L, 94L passing through groove centers of the lateral grooves 92, 93, 94 are crossed with the axial line of the cord 88a of the outermost cord layer 88 with respect to the equatorial plane E and planes P₃, P₄ parallel thereto.

In the illustrated embodiment according to the invention, the circumferential grooves 90 and 91 are not necessarily required. In this case, a tire having a lug pattern may be formed by connecting a portion of the lateral groove 92 located toward an end of the tread portion 82 to the lateral grooves 93 and 98, and connecting a portion of the lateral groove 92 located toward an end of the tread portion 82 to the lateral grooves 94 and 98, respectively.

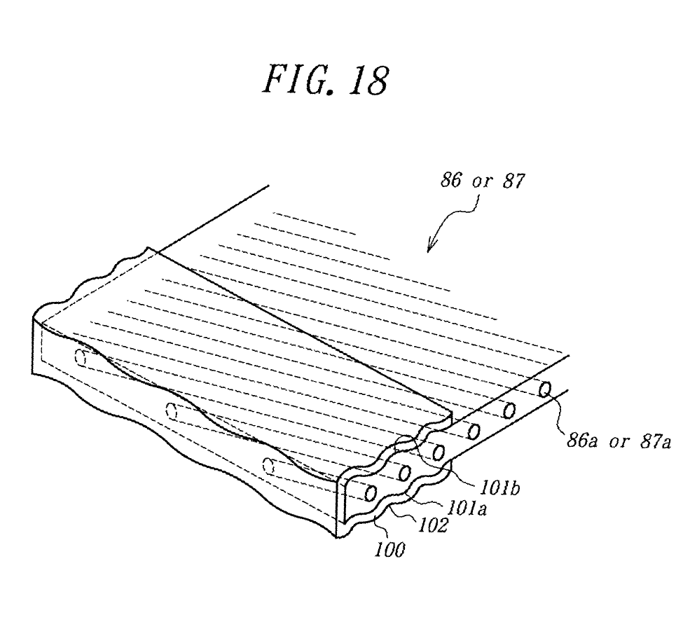

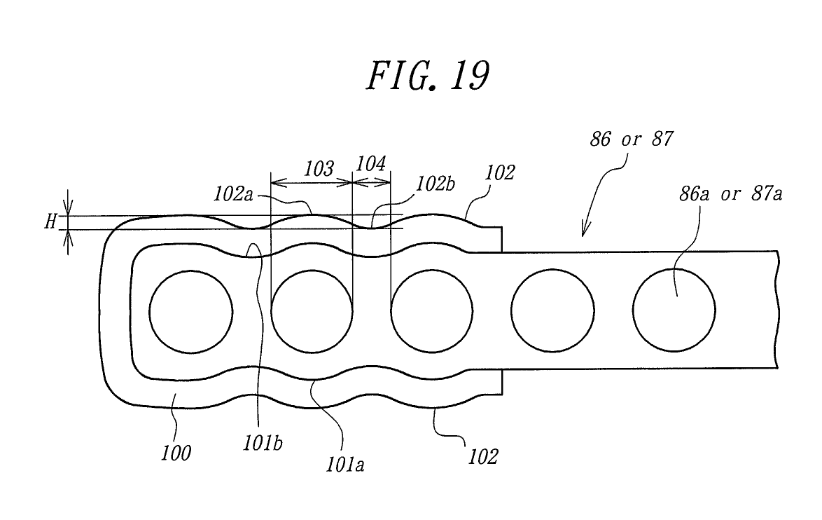

As shown in FIGS. 18 and 19, it is favorable that a sheet-shaped end cover rubber 100 is arranged in a widthwise end portion of at least one of the innermost cord layer 86 and the middle cord layer 87 so as to cover the end portion of the cord layer. At least one surface of inner surface 101a and outer surface 101b in the radial direction of the tire at the end portion of the innermost cord layer 86 or the middle cord layer 87 provided with the end cover rubber 100, the inner and outer surfaces 101a, 102b in the illustrated embodiment are a wavy surface forming a mountain part at a cord existing position (86a, 87a) and a valley part at a position between adjoining cords (86a, 87a) of the layer. As a result, the surface 102 of the end cover rubber 100 has a wavy surface consisting of mountain parts 102a and valley parts 102b. The mountain part 102a corresponds to the cord existing position 103 (86a, 87a) and the valley part 102b corresponds to the position 104 between the adjoining cords (86a, 87a). A difference of height H between the mountain part 102a and the valley part 102b is within a range of 0.05-0.25 mm. Such a height difference H largely contributes to control the occurrence of separation between the innermost cord layer 85 and the end portion of the middle cord layer 86 constituting the cross cord layer 89.

The reason why the height difference H between the mountain part 102a and the valley part 102b in the end cover rubber 100 is restricted to a range of 0.05-0.25 mm is due to the fact that when the height difference H is less than 0.05 mm, the effect of controlling the occurrence of separation at the end portion of the cross cord layer 89 is not obtained in practice, while when it exceeds 0.25 mm, a greater amount of air is enveloped in recess portions corresponding to valley parts 102b of the tire 80 during the laying of cord layer members for the belt in the building of an uncured tire and a portion enveloping air is not adhered in the vulcanization building of the uncured tire and hence separation is caused from such a portion.

The wavy form on the inner surface 101a and the outer surface 101b of the innermost cord layer 86 or the middle cord layer 87 and the surface 102 of the end cover rubber 100 is carried out by a method wherein at least one surface of at least an end portion of an uncured rubberized cord layer member cut into a given length is pushed by the same roll as comb roll aligning steel cords in a given arranging direction when a continuous cord layer member corresponding to cord layers 86, 87 for the cross cord layer 89 of the belt 85 is manufactured by calendar rolls, or by thinning rubber gauge of uncured coating rubber for the cords 86a, 87a. In the latter case, the rubber gauge is set considering the fact that if the rubber gauge of the coating rubber is too thin, the cords 86a, 87a are easily exposed at the production stage of uncured members.

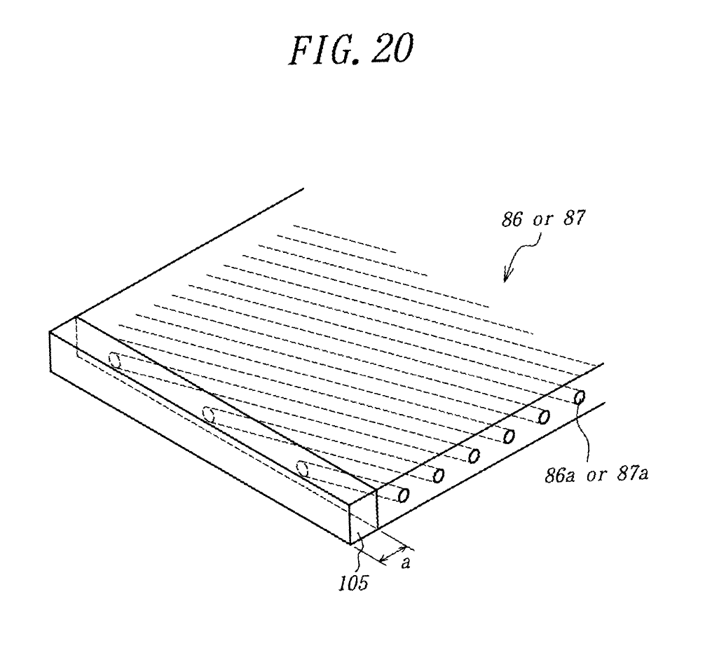

As shown in FIG. 20, a rubber layer 105 is joined to a widthwise end face of at least one of the innermost cord layer 86 and the middle cord layer 87 over a full periphery of the cord layer instead of the end cover rubber 100. The rubber layer 105 can prevent the projection of ends of the cords 86a, 87a of the innermost cord layer 86 and the middle cord layer 87 into the tread rubber 83 and contributes to improve the separation resistance at the end portion of the cross cord layer 89. In this case, the width a of the rubber layer 105 is within a range of 0.05-5.00 mm.

When the width a of the rubber layer 105 is less than 0.05 mm, the effect of controlling the occurrence of separation failure becomes too small, while when the width a exceeds 5.00 mm, if the uncured cord layer members for the innermost cord layer 86 and the middle cord layer 87 are fed onto a building drum from their feeding devices in the building of the uncured tire, the uncured rubber member for the rubber layer 105 hangs down or turn up and there is caused a problem of damaging the operability.

In case of arranging the rubber layer 105, the end cover rubber 100 may not be arranged, but the rubber layer 105 and the end cover rubber 100 may be used together. In the latter case, the surface 102 of the end cover rubber 100 is not necessarily rendered into the wavy surface 102a, 102b. Moreover, the rubber layer 105 is favorable to have the same rubber composition as coating rubbers for the cord in the innermost cord layer 86 and the cord in the middle cord layer 87 from a viewpoint of the productivity. Thus, the ends of the cords 86a of the innermost cord layer 86 and the cords 87a of the middle cord layer 87 can be protected by the rubber layer 105 having the same rubber composition, which is advantageous in the improvement of the separation resistance.

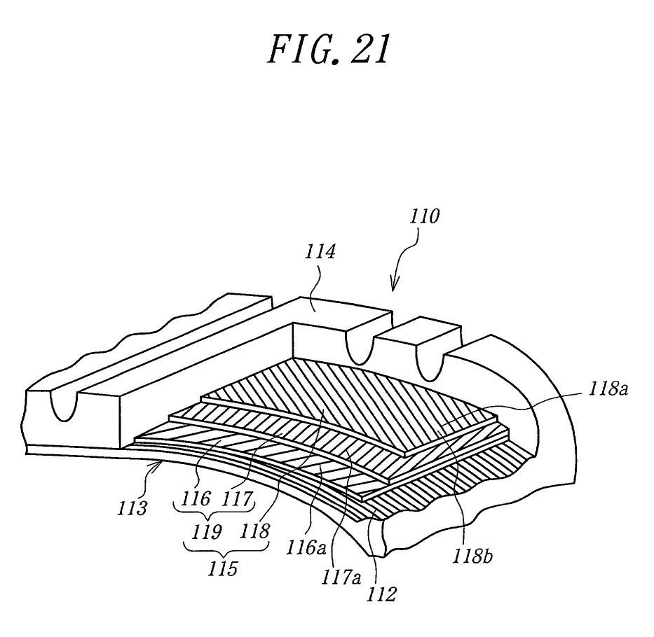

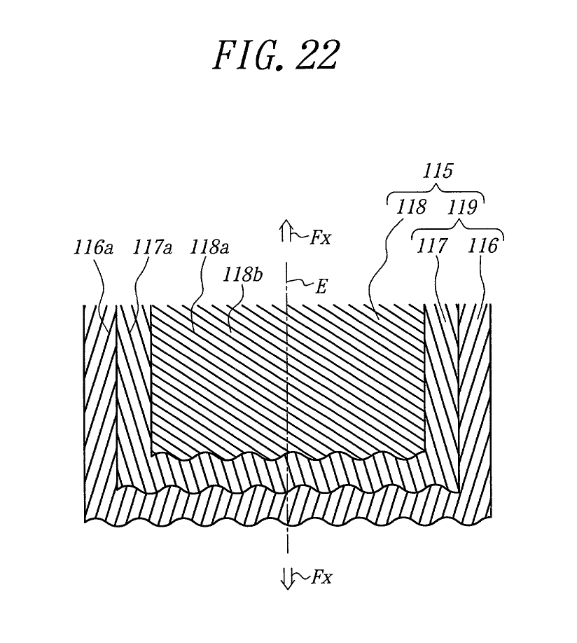

In FIGS. 21 and 22 is shown a fourth embodiment of the pneumatic radial tire according to the invention. Numeral 110 is a heavy duty pneumatic radial tire, numeral 112 a radial carcass, numeral 103 a crown portion of the carcass, numeral 114 a tread portion, numeral 105 a belt comprised of cord layers 116 to 118 and numeral 119 a cross cord layer.

In the tire 110, the belt 115 reinforcing the tread portion 114 is arranged on an outer periphery of the crown portion 113 of the radial carcass 112 toroidally extending between a pair of bead cores (not shown) embedded in a pair of bead portions (not shown). The belt 115 is comprised of three rubberized cord layers 116, 117, 118, wherein cords 116a, 117a of each of an innermost cord layer 116 and a middle cord layer 117 are crossed with each other with respect to an equatorial plane E of the tire and the innermost cord layer 116 and the middle cord layer 117 form a cross cord layer 119.

The cords 116a of the innermost cord layer 116 and the cords 117a of the middle cord layer 117 are arranged at an inclination angle of 10-25° with respect to the equatorial plane E, respectively. On the other hand, cords 118a of an outermost cord layer 118 are high-extensible cords, preferably high-extensible cords having an elongation at break of not less than 4% and are arranged at an inclination angle of 45-115°, preferably 50-100° with respect to the equatorial plane E as measured in the same direction as the inclination angle of the cord 117a of the middle cord layer 117. And also, the cord 118a in the outermost cord layer 118 is covered with a coating rubber 118b having a compression modulus of not less than 200 kgf/cm².

That is, the cords 116a of the innermost cord layer 116 and the cords 117a of the middle cord layer 117 are arranged at the inclination angle of 10-25°, preferably 15-22° with respect to the equatorial plane E, while the cords 118a of the outermost cord layer 118 are arranged at the inclination angle of 45-115° with respect to the equatorial plane E, whereby a force Fx acting to the circumferential direction of the tire created when the tire is inflated under an inner pressure as shown in FIG. 22 can be mainly born by the cords 116a and 117a of the innermost cord layer 116 and the middle cord layer 117 and tension applied to the cords 118a of the outermost cord layer 118 can slightly be shifted toward compression side, so that even if the tire rides on a sharp corner of rock, stone or the like to cause cut damage arriving at the belt, the cords 118a of the outermost cord layer 118 are hardly broken. If there is caused a state of acting tensile force to the cord 118a of the outermost cord layer 118, since the cord of the outermost cord layer is the high-extensible cord having a large elongation at break, the tensile force is effectively absorbed to hardly cause the cord breakage. In any case, the durability is improved.

In addition, the cord breakage is hardly caused by using the high-extensible cord as the cord of the outermost cord layer, so that the end count of the outermost cord layer can be decreased, whereby the weight reduction can be attained.

And also, when the tire is inflated under the inner pressure, the force Fx in the circumferential direction of the tire is applied to the belt as shown in FIG. 22 and hence each of the cords 116a, 117a tends to change into a direction of decreasing the inclination angle and finally the cord layers 116, 117 intend to contract in the widthwise direction thereof. In the belt 115 having the above structure, however, the inclination angle of the cord 118a of the outermost cord layer 118 is considerably larger than those of the cords 116a, 117a of the innermost cord layer 116 and the middle cord layer 117, so that the change of the inclination angle in the cord 118a is very small and hardly contracts in the widthwise direction, so that the outermost cord layer 118 can not follow to the contracting deformation of the cord layers 116, 117 in the widthwise direction.

Therefore, the outermost cord layer 118 acts to control the contraction of the cord layers 116, 117 in the widthwise direction (so-called prop action), whereby the rigidity of the cord layers 116, 117 in the circumferential direction is increased to increase the cornering power (CP) and to control the growth of the tire size in the inflation under the inner pressure.

Moreover, the inclination angles of the cords 116a and 117a in the innermost cord layer 116 and the middle cord layer 117 are approximately equal to each other with respect to the equatorial plane E from a viewpoint that tension is equally born by the cords 116a and 117a. The reason why the inclination angles of the cords 116a and 117a are restricted to a range of 10-25° is due to the fact that when the inclination angle is less than the lower limit, interlaminar shearing strain produced at the end portions of the cord layers 116, 117 becomes too large and the separation failure is apt to be caused between the cord layers 116 and 117 (in the cross cord layer), while when it exceeds the upper limit, the cords 116a, 117a can not sufficiently counter to the tension acting to the circumferential direction of the tire.

Even in this tire 110, as shown in FIG. 7, the adequate inclination angle of the cord 118a of the outermost cord layer 118 indicating the index value of not less than 100 (i.e. CP property is equal to or more than that of the conventional tire) is within a range of 45-115°. In this case, the tire has the cornering power equal to or more than that of the conventional tire. This is considered to be due to the fact that the cords 118a of the outermost cord layer 118 develops a sufficient prop action to enhance the rigidity of the cross cord layer in the circumferential direction.

When the cords 118a of the outermost cord layer 118 are subjected to a compression force bending inward in the widthwise direction in the riding of the tire having the above structure rides on the foreign matter such as a large stone scattered on a road surface as shown in FIG. 2, there is a fear of creating local buckling in the cord 118a of the outermost cord layer 118 and hence there is a possibility of causing cord breakage.

For this end, a coating rubber 118b having a compression modulus of not less than 200 kgf/cm² is used in the cords 118a of the outermost cord layer 118. As a result, the buckling hardly occurs even at a state as shown in FIG. 2 and the breakage of the cord 118a in the outermost cord layer 118 can sufficiently be controlled. Consequently, the durability which is apt to be lacking when the belt is comprised of three cord layers for attaining the weight reduction can be enhanced to a level equal to that of the conventional tire having the belt of four cord layers.

In the tire 110 shown in FIG. 21, it is favorable to apply an end cover rubber or a rubber layer to the end portion of at least one of the innermost cord layer 116 and the middle cord layer 117 in order to more improve the separation resistance and tire durability likewise the first to third embodiments as previously mentioned.

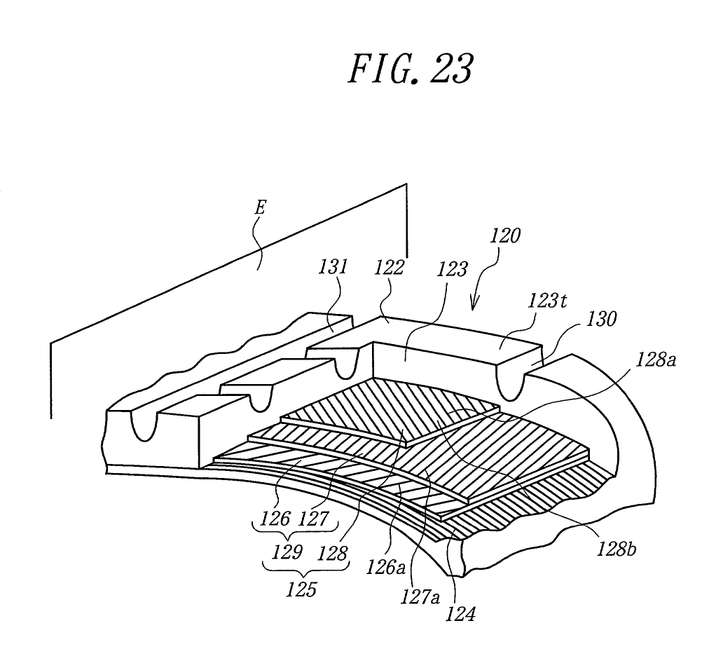

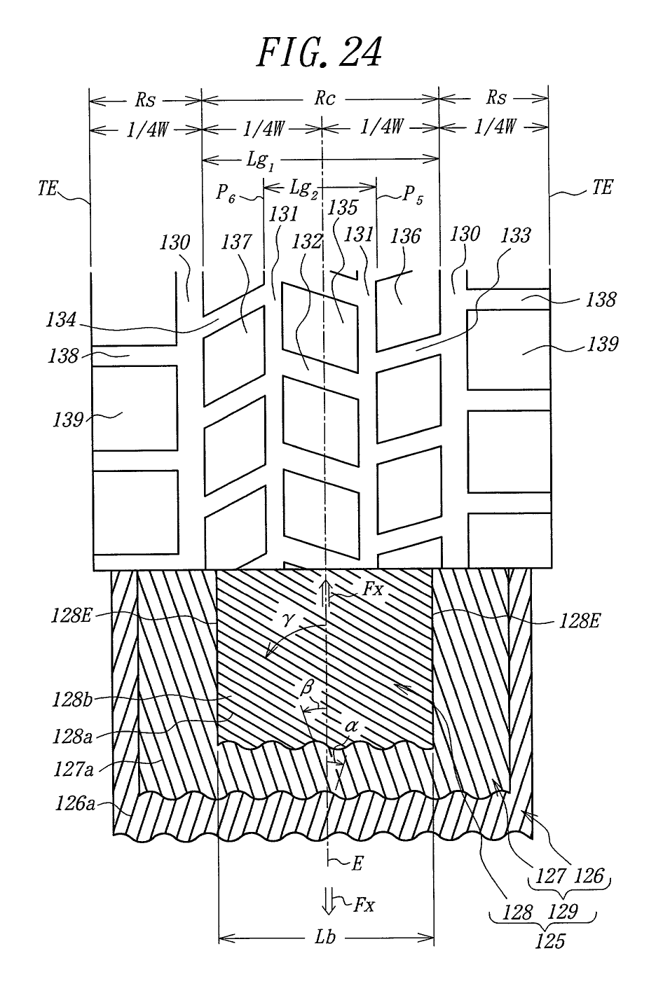

In FIGS. 23 and 24 is shown a fifth embodiment of the pneumatic radial tire according to the invention. This tire 120 comprises a pair of bead portions (not shown), a pair of sidewall portions (not shown) and a tread portion 122 extending between the pair of the sidewall portions and provided on its ground contact side with a tread rubber 123. And also, the tire 120 comprises a radial carcass 124 extending between a pair of bead cores (not shown) embedded in the bead portions to reinforce the pair of the bead portions and the pair of the sidewall portions and the tread portion and comprised of one or more rubberized cord plies, one cord ply in the illustrated embodiment and a belt 125 arranged on an outer circumference of the carcass 124 to reinforce the tread portion 122.

Referring to FIGS. 23 and 24, the belt 125 is comprised of three rubberized steel cord layers 126, 127, 128, wherein cords 126a, 127a of each of an innermost cord layer 126 nearest to the carcass 124 and a middle cord layer 127 are crossed with each other with respect to an equatorial plane E of the tire and the innermost cord layer 126 and the middle cord layer 127 form a cross cord layer 129. The cords 126a of the innermost cord layer 126 and the cords 127a of the middle cord layer 127 are arranged at an inclination angle (α, β) of 10-25°, preferably 15-22° with respect to the equatorial plane E, respectively. On the other hand, cords 128a of an outermost cord layer 128 are arranged at an inclination angle (γ) of 45-115°, preferably 50-100° with respect to the equatorial plane E as measured in the same direction as the inclination angle β of the cord 127a of the middle cord layer 127. And also, the cord 128a in the outermost cord layer 128 is covered with a coating rubber 128b having a compression modulus of not less than 200 kgf/cm².

The tread portion 122 of this tire 120 shown in FIG. 24 has a block pattern formed in the tread rubber 123 over a full region thereof. In the tread portion 122, one or more circumferential shoulder grooves, one circumferential shoulder groove 130 extending straightforward in the circumferential direction in the illustrated embodiment is provided at least on each of both side regions Rs. And also, straight circumferential center grooves 121 located on both sides of the equatorial plane E are arranged in a central region Rc of the tread portion 122. In this case, when a developed width between ends TE of a tread surface 123t of the tread portion 122 is W as shown in FIG. 24, the central region Rc is a region sandwiching the equatorial plane E from both sides with a width of 1/4W, and the both side regions Rs are regions located at the both sides of the central region with a width of 1/4W.

In the tread pattern shown in FIG. 24, the central region Rc of the tread portion 122 is provided with rows of blocks 135, 136, 137 defined by a plurality of lateral grooves 132 extending between the mutual circumferential center grooves 131, 131 and opening to the respective grooves 131 and a plurality of lateral grooves 133, 134 extending between the mutual circumferential shoulder groove 130 and circumferential center groove 131 and opening to the respective grooves 130, 131, while each of both side regions Rs of the tread portion is provided with a row of blocks 139 defined by the circumferential shoulder groove 130 and a plurality of lateral grooves 138 opening thereto.

As another example of the tread pattern, there may be taken a rib pattern wherein land portions such as ribs and the like are formed over the full region of the tread portion or a block-rib pattern of combining rib rows and block rows in the tread portion. Moreover, the circumferential grooves 130, 131 in the illustrated embodiment are straight grooves, but may be zigzag grooves.

In this embodiment, the outermost cord layer 128 has a width Lb narrower than a distance between groove edges of the circumferential shoulder grooves nearest to the equatorial plane among the circumferential shoulder grooves arranged in the both side regions Rs of the tread portion 122 as a pair, between the groove edges of the circumferential shoulder grooves 130 nearest to the equatorial plane E in the illustrated embodiment, i.e. the width Lb is narrower than a developed width Lg₁ in FIG. 24. In other words, a widthwise end 128E of the outermost cord layer 128 is located between the equatorial plane E and a groove edge position nearest to the equatorial plane E in both groove edges of the circumferential shoulder groove 130 nearest to the equatorial plane E.

And also, the width Lb of the outermost cord layer 128 is wider than a distance between mutual groove edges of the circumferential center grooves 131 located in the central region Rc and farthest from the equatorial plane E, i.e. the width Lb is wider than a developed width Lg₂ in FIG. 24. In other words, the widthwise end 128E of the outermost cord layer 128 is located between the groove edge of the circumferential shoulder groove 130 nearest to the equatorial plane E and the groove edge of the circumferential center groove 131 farthest from the equatorial plane E.

As previously mentioned, the cords 126a of the innermost cord layer 126 and the cords 127a of the middle cord layer 127 are arranged at the inclination angle (α, β) of 10-25°, preferably 15-22° with respect to the equatorial plane E, while the cords 128a of the outermost cord layer 128 are arranged at the inclination angle (γ) of 45-115°, preferably 50-100° with respect to the equatorial plane E as measured in the same direction as in the cord 127a of the middle cord layer 127, whereby circumferential tension created in the belt 125 of the tread portion 122 when the tire 120 is inflated under an inner pressure as shown by an arrow Fx in FIG. 24 is mainly born by the cords 126a and 127a of the innermost cord layer 126 and the middle cord layer 127 forming the cross cord layer 129 at a small inclination angle with respect to the equatorial plane E, so that tension to be born by the outermost cord layer 128 can largely be decreased.

Thus, when the tread portion 122 of the tire 120 during the running under loading rides on a foreign matter such as broken stone, small rock or the like having a sharp corner edge, even if the corner edge arrives at the belt 125 through the tread rubber 123, the cords 128a of the outermost cord layer 128 are hardly cut and the durability of the tire 120 is improved based on such a cut resistance.

And also, the belt 125 tends to project outward in the radial direction of the tire 120 by tension Fx created in the belt 125 when the tire 120 is inflated under the inner pressure and hence the belt 125 intends to contract inward in the widthwise direction thereof as a whole, so that the cords 126a, 127a and 128a of the cord layers 126, 127, 128 in the belt 125 are intended to change into a direction of decreasing the inclination angles α, β, γ, respectively. In the belt 125 having the above structure, however, the inclination angle γ of the cord 128a of the outermost cord layer 128 is considerably larger than those α, β of the cords 126a, 127a of the innermost cord layer 126 and the middle cord layer 127, so that the degree of decreasing the inclination angle in the cord 128a is very small as compared with those of the cords 126a, 127a and hence the outermost cord layer 128 indicates a tendency hardly causing the contraction in the widthwise direction.

This means that the outermost cord layer 128 acts to control the contraction of the cross cord layer 129 in the widthwise direction because the cords 128a of the outermost cord layer 128 acts as a prop to the cross cord layer 129. As a result, the cross cord layer 129 having the controlled widthwise contraction increases the circumferential rigidity of the tread portion 129, and hence the cornering power (CP) can be improved even in the tire 120 having the belt 125 of the three-layer structure to develop the cornering performance equal to or more than that of the conventional tire having a belt of four-layer structure. Furthermore, the increase of the circumferential rigidity in the cross cord layer 129 largely contributes to control the growth of tire size in the inflation of the tire under the inner pressure.

Moreover, the inclination angles α, β of the cords 126a and 127a in the innermost cord layer 126 and the middle cord layer 127 are approximately equal to each other with respect to the equatorial plane E and the planes P₅, P₆ parallel to the equatorial plane from a viewpoint that tension is equally born by the cords 126a and 127a. The reason why the inclination angles α, β of the cords 126a and 127a are restricted to a range of 10-25° is due to the fact that when each of the inclination angles α, β is less than 10°, interlaminar shearing strain produced between the innermost cord layer 126 and an end portion of the middle cord layer 127 becomes too large and the separation failure is apt to be caused at such an end portion, while when the inclination angle α, β exceeds 25°, the effect of controlling the widthwise contraction of the outermost cord layer 128 can not sufficiently be developed due to the tension Fx acting to the belt 125 in the tire 120 inflated under the inner pressure and hence the circumferential rigidity of the cross cord layer 129 considerably lowers to bring about the degradation of CP property and the increase of tire size growth.

Even in this tire 120, as shown in FIG. 7, the adequate inclination angle γ indicating the index value of not less than 100 (i.e. CP property is equal to or more than that of the conventional tire) is within a range of 45-115°. When the inclination angle γ is less than 45° or exceeds 115°, the CP property is degraded as compared with that of the conventional tire, so that the inclination angle γ should be within the adequate range of 45-115°. From this fact, it is proved that the cords 128a of the outermost cord layer 128 act as a prop to the widthwise contraction of the cross cord layer 129 and enhance the circumferential rigidity of the cross cord layer 129.

When the tire is run on good road thinly scattered with foreign matters such as small stones, metal pieces and the like under loading, it is elucidated that as a result of statistical analysis on position of cut damage of the tread portion through the foreign matter in many tires, the position of the cut damage concentrates in the central region Rc taking the equatorial plane E as a central axis at a state of substantially a normal distribution irrespectively of paved road surface and non-paved road surface as the good road. Therefore, when the tire 120 almost running on the good road is provided with the outermost cord layer 128 in at least a central region Rc thereof, there is substantially no fear of causing troubles resulted from the cut damage of the belt 125 through the foreign matter.

In case of the tire 120 having the circumferential shoulder grooves 130 in both side regions Rs of the tread portion 122 as shown in FIGS. 23 and 24, the occurrence of the cut damage can be more reduced by making the width of the outermost cord layer 128 narrower than the distance between the groove edges of the mutual circumferential shoulder grooves 130 nearest to the equatorial plane E, and there is actually no belt trouble based on the cut damage. Thus, the weight reduction of the tire can be attained when the width of the outermost cord layer 128 is made narrower than the width of the conventional outermost cord layer as mentioned above.

In case of the tire 120 having the circumferential center grooves 131 in the central region Rc of the tread portion as shown in FIGS. 23 and 24, the width of the outermost cord layer is made wider than the distance between the groove edges of the mutual circumferential center grooves 131 farthest from the equatorial plane E, whereby the outermost cord layer 128 can be served as a cut protection layer for the middle cored layer 127 and innermost cord layer 126 against cut applied to the bottom of the circumferential center groove 131 in the central region Rc frequently subjected to the cut damage and hence the sufficient cut resistance of the belt 125 is guaranteed.

Because, even if the corner edge of the foreign matter arrives at the belt 125 through the thin tread rubber 123 located beneath the bottom of the circumferential center groove 131, many cords 128a of the outermost cord layer 128 are always existent beneath the thin tread rubber and indicate a sufficient resistance to cut input as mentioned below.

The reason why many cords 128a of the outermost cord layer 128 are existent ahead the corner edge of the foreign matter bitten into the circumferential center groove 131 along the groove bottom thereof is due to the fact that when the circumferential center groove 141 is a straight groove, an angle defined between the groove bottom and the cord 128a of the outermost cord layer 128 is not less than 45°. In this connection, if the circumferential center groove 131 is a zigzag groove, the difference between inclination angle of the zigzag groove with respect to the plane P_{5, P}₆ parallel to the equatorial plane E and inclination angle of the cord 128a of the outermost cord layer 128 is favorably rendered into not less than 20° as measured in the same direction as the cord 127a of the middle cord layer 127. If such an inclination angle difference is less than 20°, the number of the cords 128a receiving the entrance of the corner edge of the foreign matter becomes too small.

In case of the tire 120 having no groove such as the circumferential center groove 131 in the central region Rc of the tread portion 122, the width of the outermost cord layer 128 is adaptable to be within a range of 25-70% of a width of the middle cord layer 127. Because, it is necessary that the middle cord layer 127 gives the rigidity required in the tread portion 122 to the tire 120 together with the innermost cord layer 126 and hence the middle cord layer 127 is required to have a width approximately equal to a width of a tread surface 123t of the tread portion 122 (see FIG. 23). As a result, when the width of the outermost cord layer 128 is less than 25% of the width of the middle cord layer 127, a zone of the central region Rc not countering to the cut becomes too wide, while when it exceeds 70%, there is no meaning in the weight reduction.

In any case, the cord 128a of the outermost cord layer 128 receiving the cut input of the sharp corner edge of the foreign matter is slight in the tension bearing ratio and has a sufficient energy against the cut, so that the entrance of the corner edge can be stopped by the outermost cord layer 128 to prevent the breakage of the cords 127a in the middle cord layer 127. For this end, the outermost cord layer 128 is required to have a width extending outward over the distance between the outermost groove edges of the circumferential center grooves 131 in the widthwise direction of the tire. If the circumferential center groove 131 is a zigzag groove, the outermost cord layer 128 is sufficient to have a width extending outward over a top of the outermost groove edge at the outermost position of the mountain-shaped groove in the widthwise direction of the tire.

Furthermore, when the tire 120 is run on a road surface scattered with a relatively large foreign matter such as broken stones and rocks and rides on such a foreign matter, as previously mentioned on FIG. 2, the outermost cord layer 128 in the belt 125 is forcedly subjected to a bending deformation at a large curvature and hence a large compression force is locally applied to the outermost cord layer 128 to cause buckling in the cords 128a thereof. In the invention, however, rubber having a compression modulus of not less than 200 kgf/cm² is used as a coating rubber 128b for the cord 128a in the outermost cord layer 128, whereby the compression resistance of the coating rubber 128b is increased, so that it is possible to prevent the buckling deformation of the cord 128a in the outermost cord layer 128. As a result, even when the tire frequently rides on the relatively large foreign matter such as broken stone or rock, the occurrence of cord breakage due to the buckling fatigue of the cord 128a in the outermost cord layer 128 can be prevented. When the compression modulus of the coating rubber is less than 200 kgf/cm², the above effect is insufficient.

The following examples are given in illustration of the invention and are not intended as limitations thereof.

### EXAMPLES 1-14, COMPARATIVE EXAMPLES 1-6

There are provided radial tires for truck and bus to be tested having a tire size of 11R22.5 and a structure as shown in FIGS. 5, 6 and 8-11, wherein a belt 34 has a three-layer structure comprised of innermost cord layer 35, middle cord layer 36 and outermost cord layer 37 provided that the innermost cord layer 35 and the middle cord layer 36 form a cross cord layer 38. All cords 35a, 36a, 37a of the cord layers 35, 36, 37 are made of steel cords of 1×0.34+6×0.34 and an end count in each cord layer is 18.0 cords/50 mm.

The number of cord layers in the belt 34, cord inclination angle in each cord layer (α, β, γ) and compression modulus (kgf/cm²) of coating rubber for the cord 37a of the outermost cord layer 37 are shown in Table 1. For the comparison with conventional tire and comparative tires, the inclination angles α, β, γ (°) are represented in Table 1 as a cord inclination angle of a cord layer attached by 1B, 2B, 3B, 4B (not existing in the examples) from a carcass 33 in this order. And also, symbol R attached before the value of the inclination angle means that the cords are arranged upward to the right, and symbol L means that the cords are arranged upward to the left.

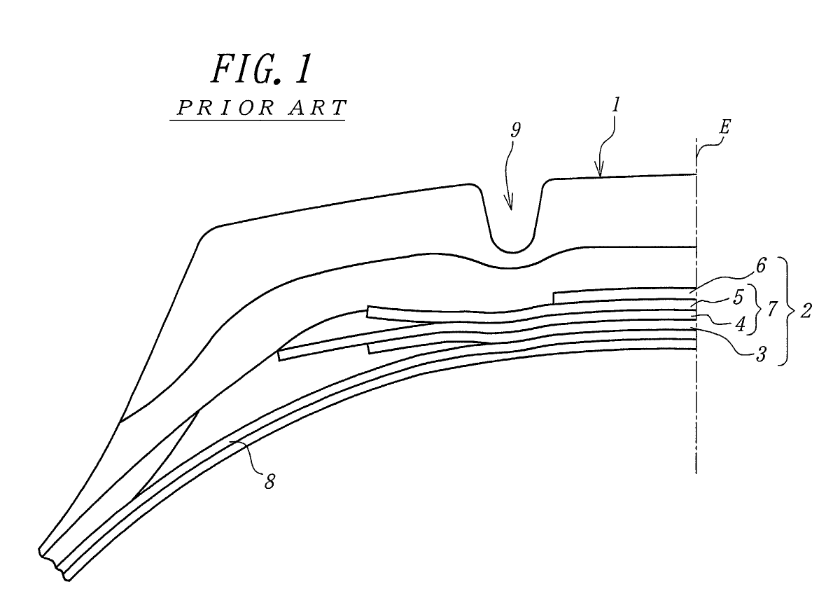

The carcass 33 is comprised of one rubberized radial carcass ply containing steel cords of (3+9+15)×0.175. The other construction of the tire is according to the custom. In order to evaluate the tires of Examples 1-14, there are provided a tire of the conventional example having the same structure as in the above example except that the belt is comprised of four cord layers as shown in FIG. 1, and tires of Comparative Examples 1-6 wherein at least one of the inclination angles of the cord layers in the belt and the compression modulus of the coating rubber 37b for the outermost cord layer 37 is outside the range defined in the invention.

With respect to the tires of Examples 1-14, conventional tire and tires of Comparative Examples 1-6, cut test for the belt, cord breakage test for the outermost cord layer, durability test (test for separation resistance of the cross cord layer) and test for cornering property through the measurement of CP are carried out as mentioned below to obtain results as shown in Table 1.

A. Cut Test of Belt;

The test tire rendered into so-called stone bitten state by biting a steel filler having a tip with an angle of 90° into a block 44 nearest to the equatorial plane E of the tire is inflated under an inner pressure of 7.5 kgf/cm² and run under a load of 2750 kgf/tire over a distance of 10,000 km. Thereafter, the tire is dissected to examine the cord cut breakage of the outermost cord layer. The durability is evaluated by the presence or absence of cord cut breakage.

B. Cord Breakage Test of Outermost Cord Layer;

After a semi-sphere having a radius of 30 mm is fixed onto a drum surface of a drum testing machine, the test tire inflated under an inner pressure of 7.5 kgf/cm² is run on the drum under a load of 2750 kgf over a distance of 10,000 km so as to locate the semi-sphere to substantially a center of the tread portion. Thereafter, the tire is dissected to examine cord breakage in the outermost cord layer. The durability is evaluated by the presence or absence of cord breakage.

C. Durability Test for Cross Cord Layer;

The test tire inflated under an inner pressure of 7.5 kgf/cm² is run under a load of 2750 kgf at a state of applying a lateral force of 0.3 g (gravity acceleration) over a distance of 1,000 km. Thereafter, the tire is dissected to measure crack length produced at the end of the middle cord layer. The belt durability is evaluated by a reciprocal of the crack length and represented by an index on the basis that the control tire is 100, wherein the larger the index value, the better the property.

D. Test for Cornering Property;

The test tire mounted onto a rim (rim size: 8.25) is run on a drum testing machine under conditions that the inner pressure is 7.5 kgf/cm² and the load is 2750 kgf, during which a slip angle is increased every 1° within a range of 1-4° and CP is calculated from cornering force measured at each of the slip angles. The cornering property is evaluated by an average value of CP and represented by an index on the basis that the conventional tire is 100, wherein the larger the index value, the better the property.

TABLE 1

| | | | | | | Compression | Height difference | | | | | |
|---|---|---|---|---|---|---|---|---|---|---|---|---|
| | | | | | | modulus of | between | Width a of | | Cord | | |
| | Number of | Cord inclination | | | | coating | mountain part | rubber | | breakage | Durability | Cornering |
| | cord layers | angle (°) | | | | rubber 37b | and valley part | layer | Cut test | test | test | property |
| | in belt | 1B | 2B | 3B | 4B | (kgf/cm²) | (mm) | (mm) | Test A | Test B | Test C | Test D |
| Conventional | 4 | R52 | R18 | L18 | L18 | 170 | 0 | 0 | absence | absence | 100.0 | 100.0 |
| Example | | | | | | | | | | | | |
| Comparative | 3 | R52 | R18 | L18 | — | 170 | 0 | 0 | presence | absence | 100.0 | 100.0 |
| Example 1 | | | | | | | | | | | | |
| Comparative | 3 | R18 | L18 | R52 | — | 170 | 0 | 0 | absence | absence | 97.0 | 98.0 |
| Example 2 | | | | | | | | | | | | |
| Comparative | 3 | R18 | L18 | L52 | — | 170 | 0 | 0 | absence | presence | 105.0 | 102.0 |
| Example 3 | | | | | | | | | | | | |
| Comparative | 3 | R9 | L9 | L52 | — | 350 | 0 | 0 | absence | absence | 98.0 | 99.5 |
| Example 4 | | | | | | | | | | | | |
| Comparative | 3 | R18 | L18 | L40 | — | 350 | 0 | 0 | absence | absence | 104.5 | 99.0 |
| Example 5 | | | | | | | | | | | | |
| Comparative | 3 | R28 | L28 | L52 | — | 350 | 0 | 0 | absence | absence | 105.0 | 98.5 |
| Example 6 | | | | | | | | | | | | |
| Example 1 | 3 | R18 | L18 | L52 | — | 350 | 0 | 0 | absence | absence | 105.0 | 102.0 |
| Example 2 | 3 | R18 | L18 | L52 | — | 200 | 0 | 0 | absence | absence | 105.0 | 102.0 |
| Example 3 | 3 | R18 | L18 | L52 | — | 350 | 0.05 | 0 | absence | absence | 108.0 | 102.0 |
| Example 4 | 3 | R18 | L18 | L52 | — | 350 | 0.15 | 0 | absence | absence | 110.0 | 102.0 |
| Example 5 | 3 | R18 | L18 | L52 | — | 350 | 0.25 | 0 | absence | absence | 115.0 | 102.0 |
| Example 6 | 3 | R18 | L18 | L52 | — | 350 | 0 | 0.05 | absence | absence | 120.0 | 102.0 |
| Example 7 | 3 | R18 | L18 | L52 | — | 350 | 0 | 0.50 | absence | absence | 123.0 | 102.0 |
| Example 8 | 3 | R18 | L18 | L45 | — | 350 | 0 | 0 | absence | absence | 105.0 | 100.0 |
| Example 9 | 3 | R18 | L18 | L60 | — | 350 | 0 | 0 | absence | absence | 105.0 | 102.5 |
| Example 10 | 3 | R10 | L10 | L52 | — | 350 | 0 | 0 | absence | absence | 100.0 | 100.0 |
| Example 11 | 3 | R15 | L15 | L52 | — | 350 | 0 | 0 | absence | absence | 104.0 | 102.0 |
| Example 12 | 3 | R22 | L22 | L52 | — | 350 | 0 | 0 | absence | absence | 106.0 | 101.0 |
| Example 13 | 3 | R25 | L25 | L52 | — | 350 | 0 | 0 | absence | absence | 106.0 | 100.0 |
| Example 14 | 3 | R25 | L25 | R65 | — | 350 | 0 | 0 | absence | absence | 100.0 | 100.0 |

As seen from the results of Table 1, the tires of Examples 1-14 maintain sound state without causing the cut breakage or cord breakage in the cords 37a of the outermost cord layer 37 in the tests A and B, and have the durability and CP property equal to or more than those of the conventional tire in the tests C and D. On the contrary, the tires of Comparative Examples 1-6 are poor in at least one of the cord breakage or cord cut breakage of the outermost cord layer and the cornering property as compared with the conventional tire.

### EXAMPLES 15-18, COMPARATIVE EXAMPLES 7-8

There are provided tires of Examples 15-18 having the same tire size and structure as in Example 1 and a tread pattern shown in FIG. 6 wherein a distance between outermost groove edges of straight circumferential grooves 40 arranged in both side regions of the tread portion 31 in widthwise direction (distance Lg in FIG. 6) is 100 mm. For the evaluation of the tires of Examples 15-18, there are provided the same conventional tire as used in Example 1 and tires of Comparative Examples 7 and 8 having the same structure as in Example 1 except that the width of the outermost cord layer is outside the range defined in the invention. With respect to these tires, the cord inclination angles and widths of cord layers 1B-4B are shown in Table 2.

The cut resistance at the bottom of the outermost circumferential groove 40 is measured with respect to these tires by the following test method to obtain results as shown in Table 2.

After the test tire is mounted onto a rim having a rim size of 8.25 and inflated under an inner pressure of 7.5 kgf/cm², an edge of a cutting steel jig having an equilateral triangle with a side of 60 mm at section and a thickness of 40 mm is pushed down along the groove bottom of the circumferential groove 40 at a rate of 1 mm/sec in a direction perpendicular to the rotating axis of the tire until the jig completely passes through the tire, during which a pushing quantity (displacement) D (cm) of the cutting jig ranging from a time of the edge contacting with the groove bottom to a time of passing through the tire and a maximum pushing force F (kgf) at the passage through the tire are detected and recorded. The cut resistance of the belt 34 at the bottom of the circumferential groove 40 is evaluated by a cut energy of DxF/2 and represented by an index on the basis that the conventional tire is 100, wherein the larger the index value, the better the property.

TABLE 2

| | Number of | Cord inclination | | | | Width of cord layer | | | | |
|---|---|---|---|---|---|---|---|---|---|---|
| | cord layers | angle (°) | | | | (mm) | | | | Cut energy |
| | in belt | 1B | 2B | 3B | 4B | 1B | 2B | 3B | 4B | (index) |
| Conventional | 4 | R52 | R18 | L18 | L18 | 150 | 180 | 150 | 80 | 100 |
| Example | | | | | | | | | | |
| Comparative | 3 | R18 | L18 | L52 | — | 180 | 150 | 90 | — | 92 |
| Example 7 | | | | | | | | | | |
| Comparative | 3 | R18 | L18 | L52 | — | 180 | 150 | 100 | — | 94 |
| Example 8 | | | | | | | | | | |
| Example 15 | 3 | R18 | L18 | L52 | — | 180 | 150 | 110 | — | 120 |
| Example 16 | 3 | R18 | L18 | L52 | — | 180 | 150 | 130 | — | 117 |
| Example 17 | 3 | R18 | L18 | L52 | — | 180 | 150 | 150 | — | 115 |
| Example 18 | 3 | R18 | L18 | L52 | — | 180 | 150 | 170 | — | 115 |

As seen from the results of Table 2, the tires of Examples 15-18 considerably improve the cut resistance of the belt 34 at the bottom of the circumferential groove 40 as compared with the conventional tire having the belt of four-layer structure, while the tires of Comparative Examples 7-8 largely degrade the cut resistance of the belt 34 at the bottom of the circumferential groove 40 as compared with the conventional tire.

### EXAMPLES 19-20, COMPARATIVE EXAMPLES 9-11

There are provided tires of Examples 19-20 having the same tire size as in Example 1 and a tread pattern as shown in FIG. 8. For the evaluation of the tires of Examples 19-20, there are provided the same conventional tire as used in Example 1 and tires of Comparative Examples 9-11 having the same structure as in Example 19 except that at least one of a ratio of rubber gauge G₂₃ (mm) between steel cord at an end of middle cord layer 36 and steel cord of outermost cord layer 37 adjacent thereto to rubber gauge G₁₂ (mm) between steel cord at an end of middle cord layer 36 and steel cord of innermost cord layer 35 adjacent thereto and width of outermost cord layer 37 is varied.

With respect to these tires, cord inclination angles and widths of cord layers 1B-4B and ratio of width W₃₇ of outermost cord layer 37 to width W₃₆ of middle cord layer 36 are shown in Table 3.

The same Test C as described in Example 1 is carried out with respect to the tires of Examples 19-20, conventional tire and tires of Comparative Examples 9-11 to measure crack length from each end of the middle cord layer 36 and outermost cord layer 37. The belt durability is evaluated by a reciprocal of the measured crack length and represented by an index on the basis that the crack length inside the end of the cord layer 3B in the conventional tire is 100 wherein the larger the index value, the better the property. The measured results are shown in Table 3. Moreover, the word “inside” means inside in the radial direction of the tire, and the word “outside” means outside in the radial direction of the tire. In the conventional tire, the results of cord layer 3B is shown in the term 2B, and the result of cord layer 4B is shown in the term 3B.

Furthermore, the same Test C as in Example 1 is continued until the occurrence of separation failure in the belt. Thus, the belt durability or separation resistance is directly evaluated by the running time until the occurrence of troubles and represented by an index on the basis that the running time of the conventional tire is 100 wherein the larger the index value, the better the property. The measured results are shown in Table 3. And also, the position of trouble in the belt is also shown in Table 3.

TABLE 3

| | | | | | | | | | | | | | | Index of | Index | Position |
|---|---|---|---|---|---|---|---|---|---|---|---|---|---|---|---|---|
| | Number | | | | | | | | | Width | Rubber | Index of | Index of | crack- | of | of |
| | of cord | Cord inclination angle | | | | Width of rubber layer | | | | ratio | gauge | cracking | cracking | ing | trou- | trouble |
| | layers | (° C.) | | | | (mm) | | | | W₃₇/ | ratio | inside end | outside | at end | ble | gener- |
| | in belt | 1B | 2B | 3B | 4B | 1B | 2B | 3B | 4B | W₃₆ | G₂₃/G₁₂ | of 2B | end of 2B | of 3B | time | ated |
| Conventional | 4 | R52 | R18 | L18 | L18 | 150 | 180 | 150 | 80 | — | — | 100 | 2000 | absence | 100 | inside |
| Example | | | | | | | | | | | | | | | | 3B |
| Comparative | 3 | R18 | L18 | L52 | — | 180 | 150 | 130 | — | 0.87 | — | 95 | 400 | 667 | 105 | inside |
| Example 9 | | | | | | | | | | | | | | | | 2B |
| Comparative | 3 | R18 | L18 | L52 | — | 180 | 150 | 190 | — | 1.27 | 0.30 | 108 | 123 | 83 | 100 | end of |
| Example 10 | | | | | | | | | | | | | | | | 3B |
| Comparative | 3 | R18 | L18 | L52 | — | 180 | 150 | 170 | — | 1.13 | 0.10 | 112 | 93 | 125 | 106 | outside |
| Example 11 | | | | | | | | | | | | | | | | 2B |
| Example 19 | 3 | R18 | L18 | L52 | — | 180 | 150 | 150 | — | 1.00 | 0.30 | 100 | 141 | 333 | 110 | inside |
| | | | | | | | | | | | | | | | | 2B |
| Example 20 | 3 | R18 | L18 | L52 | — | 180 | 150 | 170 | — | 1.13 | 0.30 | 105 | 130 | 125 | 115 | inside |
| | | | | | | | | | | | | | | | | 2B |

As seen from the results of Table 3, the tire of Comparative Example 9 in which the width of the outermost cord layer is narrower by 20 mm than the width of the middle cord layer is long in the crack length produced from the end of the middle cord layer and causes the separation failure at a relatively premature time based on the growth of such a crack, while the tire of Comparative Example 10 in which the width of the outermost cord layer is wider by 40 mm than the width of the middle cord layer is long in the crack length produced from the end of the outermost cord layer and causes the separation failure at a relatively premature time based on the growth of such a crack. In the tires of Comparative Examples 9 and 10, the running time until the occurrence of trouble is equal to or slightly higher than that of the conventional tire.

On the other hand, the tire of Comparative Example 11 in which the rubber gauge ratio G₂₃/G₁₂ is too small even if the widths of the outermost cord layer and middle cord layer are rationalized is long in the crack length from the outside end of the middle cord layer and the running time thereof is slightly higher than that of the conventional tire. On the contrary, in the tires of Examples 19-20, the cracks from the ends of the middle cord layer and outermost cord layer are shorter than those of the conventional tire and hence the running time until the occurrence of trouble is considerably longer than that of the conventional tire, which attain a level recognizing the significance in market.

### EXAMPLES 21-24, COMPARATIVE EXAMPLES 12-15

There are provided radial tires for truck and bus of Examples 21-24 having a tire size of 11R22.5 and a structure as shown in FIGS. 12 to 15, wherein a tread portion 63 is provided with a pair of circumferential center grooves 75 and a pair of circumferential shoulder grooves 76 and a belt 66 is comprised of innermost cord layer 67, middle cord layer 68 and outermost cord layer 69 provided that the innermost cord layer 67 and middle cord layer 68 form a cross cord layer 70.

All of cords 67a, 68a, 69a in the cord layers 67, 68, 69 are steel cords of 1×0.34+6×0.34 and an end count of each cord layer is 18.0 cords/50 mm and a compression modulus of a coating rubber for steel cord in the innermost cord layer and middle cord layer is 170 kgf/cm².

In the tires of Examples 21-24, cord inclination angles α, β, γ (°) in the cord layers 67, 68, 69 of the belt 66 and a compression modulus of a coating rubber 69b for steel cord in the outermost cord layer 69 are shown L12 in Table 4. After a maximum distance d12 (mm) between line segment L12 and cord layer line C69 and a maximum distance d13 (mm) between line segment L13 and cord layer line C69 are measured, a larger value among the measured values is shown as maximum distance d (mm) in Table 4. For the comparison with conventional tire and comparative tires, the inclination angles α, β, γ (°) are represented in Table 4 as a cord inclination angle of a cord layer attached by 1B, 2B, 3B, 4B (not existing in the examples and comparative examples) from a carcass 65 in this order. And also, symbol R attached before the value of the inclination angle means that the cords are arranged upward to the right, and symbol L means that the cords are arranged upward to the left. The carcass 65 is one rubberized radial ply containing steel cords of (3+9+15)×0.175 therein.

For the comparison, there are provided conventional tire shown in FIG. 1 having the same structure as in Example 21 except for the belt structure and tires of Comparative Examples 12-15 having the same structure as in Example 21 except for the belt structure as shown in Table 4.

Each of these tires is mounted onto a truck and actually run on bad road over a distance of 50,000 km and thereafter taken out from the truck. Then, the remaining tread rubber is cut out from the tire to expose the outermost cord layer of the belt and then the peeling operation of the outermost cord layer is first evaluated and thereafter cut damage and cord breakage state of the peeled outermost cord layer are examined and the presence or absence of cut damage in the middle cord layer is observed. The results are also shown in Table 4. Particularly, the peeling operability is evaluated by difficulty of the peeling and bad influence to the middle cord layer and represented by an index on the basis that the conventional tire is 100 wherein the larger the index value, the better the property.

TABLE 4

| | | | | | | | Cut resistance | Resistance | |
|---|---|---|---|---|---|---|---|---|---|
| | Cord inclination | | | | Compression | Maximum | of outermost | to cord | Peeling |
| | angle (° C.) | | | | modulus | distance | cord layer 69 | breaking | operability |
| | 1B | 2B | 3B | 4B | (kgf/cm²) | d (mm) | (index) | (index) | (index) |
| Conventional | R52 | R18 | L18 | L18 | 170 | 1.0 | 100 | 100 | 100 |
| Example | | | | | | | | | |
| Comparative | R52 | R18 | L18 | — | 170 | 1.3 | 55 | 100 | 85 |
| Example 12 | | | | | | | | | |
| Comparative | R18 | L18 | L18 | — | 170 | 1.5 | 93 | 100 | 75 |
| Example 13 | | | | | | | | | |
| Comparative | R18 | L18 | L52 | — | 170 | 1.0 | 107 | 91 | 100 |
| Example 14 | | | | | | | | | |
| Comparative | R18 | L18 | L52 | — | 350 | 1.2 | 107 | 110 | 90 |
| Example 15 | | | | | | | | | |
| Example 21 | R18 | L18 | L52 | — | 350 | 1.0 | 107 | 110 | 100 |
| Example 22 | R18 | L18 | L52 | — | 200 | 1.0 | 107 | 100 | 100 |
| Example 23 | R18 | L18 | L52 | — | 350 | 0.6 | 107 | 110 | 120 |
| Example 24 | R18 | L18 | L52 | — | 350 | 0.3 | 107 | 110 | 135 |

As seen from the results of Table 4, the tires of Examples 21-24 are excellent in the cut resistance of the belt, resistance to cord breakage in the outermost cord layer and peeling operability of the cord layer as compared with the conventional tire and the tires of Comparative Examples 12-13. Furthermore, the tires of Examples 21-24 are excellent in the resistance to cord breakage and the peeing operability as compared with the tire of Comparative Example 14. Moreover, the tires of Examples 21-24 are considerably excellent in the peeling operability as compared with the tire of Comparative Example 15.

As mentioned above, the tires of Examples 21-24 are tires having not only the excellent durability on bad road but also the excellent recappability inclusive of the peeling operability.

### EXAMPLES 25-38, COMPARATIVE EXAMPLES 16-21

There are provided radial tires for truck and bus of Examples 25-38 having a tire size of 11R22.5 and a structure as shown in FIGS. 16-20, wherein a belt 85 is comprised of innermost cord layer 86, middle cord layer 87 and outermost cord layer 88 provided that the innermost cord layer 86 and the middle cord layer 87 form a cross cord layer 89. All of cords 86a, 87a, 88a of the cord layers 86, 87, 88 are steel cords of 1×0.34+6×0.34 and an end count in each cord layer is 18.0 cords/50 mm.

With respect to these tires, the number of cord layers in the belt, cord inclination angles α, β, γ (°) of the cord layers and compression modulus of a coating rubber 88b for the outermost cord layer 88 are shown in Table 5. For the comparison with conventional tire and comparative tires, the inclination angles α, β, γ (°) are represented in Table 5 as a cord inclination angle of a cord layer attached by 1B, 2B, 3B, 4B (not existing in the examples) from a carcass 84 in this order. And also, symbol R attached before the value of the inclination angle means that the cords are arranged upward to the right, and symbol L means that the cords are arranged upward to the left.

The carcass 84 is one rubberized radial ply containing steel cords of (3+9+15)×0.175 therein. The other construction of the tire is according to the custom. In order to evaluate the tires of Examples 25-38, there are provided the conventional tire having the same structure as in the above example except that the belt is comprised of four cord layers as shown in FIG. 1, and tires of Comparative Examples 16-21 wherein at least one of the inclination angles of the cord layers in the belt and the compression modulus of the coating rubber 88b for the outermost cord layer 88 is outside the range defined in the invention.

With respect to the tires of Examples 25-38, conventional tire and tires of Comparative Examples 16-21, the same tests A-D as in Example 1 are carried out to obtain results as shown in Table 5.

TABLE 5

| | | | | | | Compression | Height difference | | | | | |
|---|---|---|---|---|---|---|---|---|---|---|---|---|
| | | | | | | modulus of | between | Width a of | | Cord | | |
| | Number of | Cord inclination | | | | coating | mountain part | rubber | Cut | breakage | Durability | Cornering |
| | cord layers | angle (°) | | | | rubber 88b | and valley part | layer | test | test | test | property |
| | in belt | 1B | 2B | 3B | 4B | (kgf/cm²) | (mm) | (mm) | Test A | Test B | Test C | Test D |
| Conventional | 4 | R52 | R18 | L18 | L18 | 170 | 0 | 0 | absence | absence | 100.0 | 100.0 |
| Example | | | | | | | | | | | | |
| Comparative | 3 | R52 | R18 | L18 | — | 170 | 0 | 0 | presence | absence | 100.0 | 100.0 |
| Example 16 | | | | | | | | | | | | |
| Comparative | 3 | R18 | L18 | R52 | — | 170 | 0 | 0 | absence | absence | 97.0 | 98.0 |
| Example 17 | | | | | | | | | | | | |
| Comparative | 3 | R18 | L18 | L52 | — | 170 | 0 | 0 | absence | presence | 105.0 | 102.0 |
| Example 18 | | | | | | | | | | | | |
| Comparative | 3 | R9 | L9 | L52 | — | 350 | 0 | 0 | absence | absence | 98.0 | 99.5 |
| Example 19 | | | | | | | | | | | | |
| Comparative | 3 | R18 | L18 | L40 | — | 350 | 0 | 0 | absence | absence | 104.5 | 99.0 |
| Example 20 | | | | | | | | | | | | |
| Comparative | 3 | R28 | L28 | L52 | — | 350 | 0 | 0 | absence | absence | 105.0 | 98.5 |
| Example 21 | | | | | | | | | | | | |
| Example 25 | 3 | R18 | L18 | L52 | — | 350 | 0 | 0 | absence | absence | 105.0 | 102.0 |
| Example 26 | 3 | R18 | L18 | L52 | — | 200 | 0 | 0 | absence | absence | 105.0 | 102.0 |
| Example 27 | 3 | R18 | L18 | L52 | — | 350 | 0.05 | 0 | absence | absence | 108.0 | 102.0 |
| Example 28 | 3 | R18 | L18 | L52 | — | 350 | 0.15 | 0 | absence | absence | 110.0 | 102.0 |
| Example 29 | 3 | R18 | L18 | L52 | — | 350 | 0.25 | 0 | absence | absence | 115.0 | 102.0 |
| Example 30 | 3 | R18 | L18 | L52 | — | 350 | 0 | 0.05 | absence | absence | 120.0 | 102.0 |
| Example 31 | 3 | R18 | L18 | L52 | — | 350 | 0 | 0.50 | absence | absence | 123.0 | 102.0 |
| Example 32 | 3 | R18 | L18 | L45 | — | 350 | 0 | 0 | absence | absence | 105.0 | 100.0 |
| Example 33 | 3 | R18 | L18 | L60 | — | 350 | 0 | 0 | absence | absence | 105.0 | 102.5 |
| Example 34 | 3 | R10 | L10 | L52 | — | 350 | 0 | 0 | absence | absence | 100.0 | 100.0 |
| Example 35 | 3 | R15 | L15 | L52 | — | 350 | 0 | 0 | absence | absence | 104.0 | 102.0 |
| Example 36 | 3 | R22 | L22 | L52 | — | 350 | 0 | 0 | absence | absence | 106.0 | 101.0 |
| Example 37 | 3 | R25 | L25 | L52 | — | 350 | 0 | 0 | absence | absence | 106.0 | 100.0 |
| Example 38 | 3 | R25 | L25 | R65 | — | 350 | 0 | 0 | absence | absence | 100.0 | 100.0 |

As seen from the results of Table 5, the tires of Examples 25-38 maintain sound state without causing the cut breakage or cord breakage in the cords 88a of the outermost cord layer 88 in the tests A and B, and have the durability and CP property equal to or more than those of the conventional tire in the tests C and D. On the contrary, the tires of Comparative Examples 16-21 are poor in at least one of the cord breakage or cord cut breakage of the outermost cord layer and the cornering property as compared with the conventional tire.

### EXAMPLES 39-41, COMPARATIVE EXAMPLES 22-24

There are provided tires of Examples 39-41 having the same tire size and structure as in Example 25 and a tread pattern shown in FIG. 17 wherein an inclination angle δ (°) of a line 92L passing through a width center of a lateral groove 92 formed in a tread rubber 83 of a tread portion 82 with respect to an equatorial plane E of the tire is varied. For the evaluation of the tires of Examples 39-41, there are provided the same conventional tire as used in Example 25 and tires of Comparative Examples 22-24 having the same structure as in Example 25 except that the inclination angle δ (°) in the lateral groove 92 is outside the range defined in the invention.

The cord inclination angles α, β, γ (°) of cord layers 1B-4b, inclination angle δ(°) of lateral groove 92 in a row of blocks 95 and inclination angle difference between inclination angle γ of cord 88a in the outermost cord layer 88 and inclination angle δ of lateral groove 92 are shown in Table 6.

The cut resistance at the bottom of the lateral groove 92 is measured in the same manner as described in Example 15 with respect to these tires to obtain results as shown in Table 6.

TABLE 6

| | | | | | | Inclination | Inclination | |
|---|---|---|---|---|---|---|---|---|
| | | | | | | angle δ of | angle difference | |
| | Number of | Cord inclination | | | | lateral | (°) | Cut |
| | cord layers | angle (° C.) | | | | groove 92 | δ − γ | energy |
| | in belt | 1B | 2B | 3B | 4B | (°) | γ − δ | (index) |
| Conventional | 4 | R52 | R18 | L18 | L18 | L18 | 0 | 100 |
| Example | | | | | | | | |
| Comparative | 3 | R18 | L18 | L52 | — | L37 | 15 | 96 |
| Example 22 | | | | | | | | |
| Comparative | 3 | R18 | L18 | L52 | — | L52 | 0 | 87 |
| Example 23 | | | | | | | | |
| Comparative | 3 | R18 | L18 | L52 | — | L67 | 15 | 95 |
| Example 24 | | | | | | | | |
| Example 39 | 3 | R18 | L18 | L52 | — | L22 | 30 | 109 |
| Example 40 | 3 | R18 | L18 | L52 | — | L82 | 30 | 160 |
| Example 41 | 3 | R18 | L18 | L52 | — | R52 | 104 | 157 |

As seen from the results of Table 6, the tires of Examples 39-41 have the cut resistance of the belt 85 at the bottom of the lateral groove 92 equal to or more than that of the conventional tire having the belt of four-layer structure, while the tires of Comparative Examples 22-24 largely degrade the cut resistance of the belt 85 at the bottom of the lateral groove 92 as compared with the conventional tire.

### EXAMPLES 42-55, COMPARATIVE EXAMPLES 25-30

There are provided pneumatic radial tires of Examples 42-55 having a tire size of 11R22.5 and a structure as shown in FIGS. 21 and 22, wherein a belt 115 is comprised of three cord layers 116-118. In this case, cords 116a and 117a of innermost cord layer 116 and middle cord layer 117 are steel cords of (1+6)×0.34 and an end count of each cord layer is 18.0 cords/50 mm. An elongation at break of each of these cords 116a and 117a is 2.5%.

On the other hand, cords 118a of an outermost cord layer 118 are high-extensible strand ropes each having a cord structure of 4×4×0.23 obtained by twisting 4 steel filaments to form a strand and twisting four strands in the same direction, and an end count of this layer is 14.7 cords/50 mm. An elongation at break of the rope is 3.0%.

The number of cord layers in the belt, cord inclination angles (°) in the belt and a compression modulus of a coating rubber 118b for the outermost cord layer 118 are shown in Table 7.

A carcass 112 is comprised of one rubberized radial ply containing steel cords of (3+9+15)×0.175. The other structure of the tire is the same as in the usual pneumatic radial tire for truck and bus.

For the comparison, there are provided the conventional tire having a belt of four-layer structure as shown in FIG. 1, and tires of Comparative Examples 25-30 wherein at least one of the cord inclination angles in the belt and the compression modulus of the coating rubber for the outermost cord layer is outside the range defined in the invention. In the conventional example and Comparative Examples 25-30, all cords used in the belt are steel cords of (1+6)×0.34 having an elongation at break of 2.5% and an end count of each cord layer is 18.0 cords/50 mm.

The same tests A to D as described in Example 1 are carried out with respect to these tires to obtain results as shown in Table 7.

TABLE 7

| | | | | | | Compression | Height difference | | | | | |
|---|---|---|---|---|---|---|---|---|---|---|---|---|
| | | | | | | modulus of | between | Width a of | | Cord | | |
| | Number of | Cord inclination | | | | coating | mountain part | rubber | Cut | breakage | Durability | Cornering |
| | cord layers | angle (°) | | | | rubber 118b | and valley part | layer | test | test | test | property |
| | in belt | 1B | 2B | 3B | 4B | (kgf/cm²) | (mm) | (mm) | Test A | Test B | Test C | Test D |
| Conventional | 4 | R52 | R18 | L18 | L18 | 170 | 0 | 0 | absence | absence | 100.0 | 100.0 |
| Example | | | | | | | | | | | | |
| Comparative | 3 | R52 | R18 | L18 | — | 170 | 0 | 0 | presence | absence | 100.0 | 100.0 |
| Example 25 | | | | | | | | | | | | |
| Comparative | 3 | R18 | L18 | R52 | — | 170 | 0 | 0 | absence | absence | 97.0 | 98.0 |
| Example 26 | | | | | | | | | | | | |
| Comparative | 3 | R18 | L18 | L52 | — | 170 | 0 | 0 | absence | presence | 105.0 | 102.0 |
| Example 27 | | | | | | | | | | | | |
| Comparative | 3 | R9 | L9 | L52 | — | 350 | 0 | 0 | absence | absence | 98.0 | 99.5 |
| Example 28 | | | | | | | | | | | | |
| Comparative | 3 | R18 | L18 | L40 | — | 350 | 0 | 0 | absence | absence | 104.5 | 99.0 |
| Example 29 | | | | | | | | | | | | |
| Comparative | 3 | R28 | L28 | L52 | — | 350 | 0 | 0 | absence | absence | 105.0 | 98.5 |
| Example 30 | | | | | | | | | | | | |
| Example 42 | 3 | R18 | L18 | L52 | — | 350 | 0 | 0 | absence | absence | 105.0 | 102.0 |
| Example 43 | 3 | R18 | L18 | L52 | — | 200 | 0 | 0 | absence | absence | 105.0 | 102.0 |
| Example 44 | 3 | R18 | L18 | L52 | — | 350 | 0.05 | 0 | absence | absence | 108.0 | 102.0 |
| Example 45 | 3 | R18 | L18 | L52 | — | 350 | 0.15 | 0 | absence | absence | 110.0 | 102.0 |
| Example 46 | 3 | R18 | L18 | L52 | — | 350 | 0.25 | 0 | absence | absence | 115.0 | 102.0 |
| Example 47 | 3 | R18 | L18 | L52 | — | 350 | 0 | 0.05 | absence | absence | 120.0 | 102.0 |
| Example 48 | 3 | R18 | L18 | L52 | — | 350 | 0 | 0.50 | absence | absence | 123.0 | 102.0 |
| Example 49 | 3 | R18 | L18 | L45 | — | 350 | 0 | 0 | absence | absence | 105.0 | 100.0 |
| Example 50 | 3 | R18 | L18 | L60 | — | 350 | 0 | 0 | absence | absence | 105.0 | 102.5 |
| Example 51 | 3 | R10 | L10 | L52 | — | 350 | 0 | 0 | absence | absence | 100.0 | 100.0 |
| Example 52 | 3 | R15 | L15 | L52 | — | 350 | 0 | 0 | absence | absence | 104.0 | 102.0 |
| Example 53 | 3 | R22 | L22 | L52 | — | 350 | 0 | 0 | absence | absence | 106.0 | 101.0 |
| Example 54 | 3 | R25 | L25 | L52 | — | 350 | 0 | 0 | absence | absence | 106.0 | 100.0 |
| Example 55 | 3 | R25 | L25 | R65 | — | 350 | 0 | 0 | absence | absence | 100.0 | 100.0 |

As seen from Table 7, the tires of Examples 42-55 maintain a sound state without causing the cut breakage or cord breakage in the cords of the outermost cord layer 88 in the tests A and B, and have the durability and CP property equal to or more than those of the conventional tire in the tests C and D. On the contrary, the tires of Comparative Examples 25-30 are poor in at least one of the cord breakage or cord cut breakage of the outermost cord layer and the cornering property as compared with the conventional tire.

### EXAMPLES 56-61

There are provided radial tires of Examples 56-61 having the same structure as in Example 42 except that as the cord 118a of the outermost cord layer 118 are used high-extensible cords having an elongation at break of 3.5%, 4.0%, 4.5%, 5.0%, 5.5% or 6.0% by changing at least one of cord structure and twisting pitch as shown in Table 8. The belt durability is evaluated by measuring the cut energy indicating the easiness of cord breakage in the same manner as described in Example 15 to obtain results as shown in Table 8 together with the results of the conventional example and Example 42.

TABLE 8

| | Outermost cord layer | | | |
|---|---|---|---|---|
| | | | Elongation | |
| | | End count | at break | Belt |
| | Cord structure | (cords/50 mm) | (%) | durability |
| Conventional | 1 + 6 × 0.34 | 18.0 | 2.5 | 100 |
| Example | | | | |
| Example 42 | 4 × 4 × 0.23 | 14.7 | 3.0 | 103 |
| Example 56 | 4 × 4 × 0.23 | 14.7 | 3.5 | 107 |
| Example 57 | 4 × 4 × 0.23 | 14.7 | 4.0 | 110 |
| Example 58 | 4 × 4 × 0.23 | 14.7 | 4.5 | 114 |
| Example 59 | 4 × 4 × 0.23 | 14.7 | 5.0 | 119 |
| Example 60 | 3 × 7 × 0.23 | 11.2 | 5.5 | 124 |
| Example 61 | 3 × 7 × 0.23 | 11.2 | 6.0 | 128 |

As seen from the results of Table 8, the tires of Examples 56-61 wherein the elongation at break of the cord in the outermost cord layer is larger than that of Example 42 are superior in the durability to the tire of Example 42.

### EXAMPLES 62-65, COMPARATIVE EXAMPLES 31-34

There are provided radial tires for truck and bus of Examples 62-65 having a tire size of 11R22.5 and a structure as shown in FIGS. 23 and 24 wherein a tread portion 122 is provided with a pair of circumferential shoulder grooves 130 and a pair of circumferential center grooves 131 and a distance between groove edges of the circumferential shoulder grooves 130 corresponding to a developed width Lg₁ shown in FIG. 24 is 100 mm and a distance between groove edges of the circumferential center grooves 131 corresponding to a developed width Lg₂ shown in FIG. 24 is 35 mm.

A belt 125 has a three-layer structure comprised of innermost cord layer 126, middle cord layer 127 and outermost cord layer 128 provided that the innermost cord layer 126 and the middle cord layer 127 form a cross cord layer 129. All cords 126a, 127a, 128a of the cord layers 126, 127, 128 are made of steel cords of ×0.34+6×0.34 and an end count in each cord layer is 18.0 cords/50 mm. A compression modulus of a coating rubber 128b for the outermost cord layer 128 is 350 kgf/cm² and a compression modulus of a coating rubber for the innermost cord layer 126 and middle cord layer 127 is 170 kgf/cm².

The cord inclination angles α, β, γ (°) and widths (mm) of the cord layers 126, 127 and 128 in the belt 125 are shown in Table 9. For the comparison with conventional tire and comparative tires, the inclination angles α, β, γ (°) are represented in Table 9 as a cord inclination angle of a cord layer attached by 1B, 2B, 3B, 4B (not existing in the examples) from a carcass 124 in this order. And also, symbol R attached before the value of the inclination angle means that the cords are arranged upward to the right, and symbol L means that the cords are arranged upward to the left.

The carcass 124 is comprised of one rubberized radial carcass ply containing steel cords of (3+9+15)×0.175. The other construction of the tire is according to the custom. In order to evaluate the tires of Examples 62-65, there are provided a tire of the conventional example having the same structure as in the above example except that the belt is comprised of four cord layers as shown in FIG. 1, and tires of Comparative Examples 31-34 having the same structure as in Examples 62-65 except that the width of the outermost cord layer 128 is outside the range defined in the invention.

The belt durability is evaluated by measuring the cut energy indicating the easiness of cord breakage in the same manner as described in Example 15 to obtain results as shown in Table 9.

TABLE 9

| | Number of | Cord inclination | | | | Width of cord layer | | | | Cut |
|---|---|---|---|---|---|---|---|---|---|---|
| | cord layers | angle (°) | | | | (mm) | | | | energy |
| | in belt | 1B | 2B | 3B | 4B | 1B | 2B | 3B | 4B | (index) |
| Conventional | 4 | R52 | R18 | L18 | L18 | 150 | 180 | 150 | 80 | 100 |
| Example | | | | | | | | | | |
| Comparative | 3 | R18 | L18 | L52 | — | 180 | 150 | 25 | — | 80 |
| Example 31 | | | | | | | | | | |
| Comparative | 3 | R18 | L18 | L52 | — | 180 | 150 | 35 | — | 82 |
| Example 32 | | | | | | | | | | |
| Comparative | 3 | R18 | L18 | L52 | — | 180 | 150 | 120 | — | 98 |
| Example 33 | | | | | | | | | | |
| Comparative | 3 | R18 | L18 | L52 | — | 180 | 150 | 140 | — | 97 |
| Example 34 | | | | | | | | | | |
| Example 62 | 3 | R18 | L18 | L52 | — | 180 | 150 | 45 | — | 107 |
| Example 63 | 3 | R18 | L18 | L52 | — | 180 | 150 | 60 | — | 104 |
| Example 64 | 3 | R18 | L18 | L52 | — | 180 | 150 | 80 | — | 102 |
| Example 65 | 3 | R18 | L18 | L52 | — | 180 | 150 | 100 | — | 100 |

As seen from the results of Table 9, the tires of Examples 62-65 have the cut energy equal to or more than that of the conventional example though the belt is comprised of the three cord layers, which indicate an excellent cut resistance as compared with the conventional tire. On the other hand, the tires of Comparative examples 31-34 are poor in the cut resistance as compared with the conventional tire because the width of the outermost cord layer is outside the range defined in the invention.

As mentioned above, according to the invention, there can be provided a long-life pneumatic radial tire rendering a belt into a structure of three rubberized cord layers for holding weight reduction and improving performances required for the tire such as separation resistance of belt, cornering performance and the like at a level equal to or more than those of the conventional tire having a belt comprised of four rubberized cord layers and capable of simultaneously and largely improving cut resistance of belt as a whole of the tire including cut resistance in a circumferential groove of a tread pattern during the running on bad road and fatigue resistance of cords in an outermost cord layer constituting the belt.

What is claimed is:

1. A pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane of the tire, and one or more circumferential grooves provided in at least each side region of the tread portion, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and the outermost cord layer has a width extending toward an end of the tread portion over an outermost groove edge of an outermost circumferential groove in a widthwise direction of the tread portion.

2. A pneumatic radial tire according to claim 1, wherein a coating rubber for the cords of the outermost cord layer has a compression modulus of not less than 200 kgf/cm².

3. A pneumatic radial tire according to claim 1, wherein the outermost cord layer has a width covering both widthwise ends of the middle cord layer.

4. A pneumatic radial tire according to claim 3, wherein the width of the outermost cord layer corresponds to 1.0-1.2 times the width of the middle cord layer.

5. A pneumatic radial tire according to claim 3, wherein a rubber gauge between the cord at an end portion of the middle cord layer and the cord of the outermost cord layer adjacent thereto is not less than 0.15 time a rubber gauge between the cord at the end portion of the middle cord layer and the cord of the innermost cord layer adjacent thereto.

6. A pneumatic radial tire according to claim 1, wherein an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm.

7. A pneumatic radial tire according to claim 1, wherein at least one of the innermost cord layer and the middle cord layer is provided with a rubber layer joined to a widthwise end face of the cord layer over a full periphery of the cord layer, and the rubber layer has a width of 0.05-5.00 mm.

8. A pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and at least two circumferential grooves provided in at least a central region of the tread portion, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and a cord layer line passing through a center of a thickness of the outermost cord layer at a radial section of the tire is either one of a curved line and a combined line of a curved line and a straight line, and a maximum distance from the cord layer line to a line segment connecting two intersects between the cord layer line and each of extended lines equally dividing a groove width of each of the adjoining circumferential grooves at a radial section of the tire having a state of fitting an outer width between the pair of the bead portions to a width of an approved rim is not more than 1 mm.

9. A pneumatic radial tire according to claim 8, wherein a coating rubber for the cords of the outermost cord layer has a compression modulus of not less than 200 kgf/cm².

10. A pneumatic radial tire according to claim 8, wherein the cord layer line has a center of curvature located inward in the radial direction of the tire over a full width of the outermost cord layer.

11. A pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and a tread portion provided with a plurality of lateral grooves extending from an inside of the tread portion toward an end thereof, characterized in that the cords of each of the innermost cord layer and the middle cord layer have an inclination angle of 10-25° with respect to the equatorial plane, and cords of an outermost cord layer have an inclination angle of 45-115° with respect to the equatorial plane as measured in the same direction as in the cords of the middle cord layer, and an inclination angle of a center line of a groove width of the lateral groove with respect to a plane parallel to the equatorial plane has an inclination angle difference of not less than 20° with respect to an axial line of the cord in the outermost cord layer having the above inclination angle with respect to the equatorial plane.

12. A pneumatic radial tire according to claim 11, wherein a coating rubber for the cords of the outermost cord layer has a compression modulus of not less than 200 kgf/cm².

13. A pneumatic radial tire according to claim 11, wherein the center line of the groove width of the lateral groove is crossed with the axial line of the cord in the outermost cord layer with respect to the plane parallel to the equatorial plane.

14. A pneumatic radial tire according to claim 11, wherein an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm.

15. A pneumatic radial tire according to claim 11, wherein at least one of the innermost cord layer and the middle cord layer is provided with a rubber layer joined to a widthwise end face of the cord layer over a full periphery of the cord layer, and the rubber layer has a width of 0.05-5.00 mm.

16. A pneumatic radial tire comprising a radial carcass comprised of at least one rubberized cord ply extending between a pair of bead cores embedded in a pair of bead portion and reinforcing a pair of sidewall portions and a tread portion and a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, characterized in that the cords of each of the innermost cord layer and the middle cord layer have an inclination angle of 10-25° with respect to the equatorial plane, and cords of an outermost cord layer are high-extensible cords and have an inclination angle of 45-115° with respect to the equatorial plane as measured in the same direction as in the cords of the middle cord layer.

17. A pneumatic radial tire according to claim 16, wherein a coating rubber for the cords of the outermost cord layer has a compression modulus of not less than 200 kgf/cm².

18. A pneumatic radial tire according to claim 16, wherein the high-extensible cord has an elongation at break of not less than 4%.

19. A pneumatic radial tire according to claim 16, wherein an end portion of at least one of the innermost cord layer and the middle cord layer is provided with an sheet-shaped end cover rubber enveloping such an end portion, and at least one surface of inner and outer surfaces of the cord layer end portion provided with the end cover rubber is a wavy surface forming a mountain part at a cord existing position and a valley part at a position between adjoining cords, and a difference of height between the mountain part and the valley part is within a range of 0.05-0.25 mm.

20. A pneumatic radial tire according to claim 16, wherein at least one of the innermost cord layer and the middle cord layer is provided with a rubber layer joined to a widthwise end face of the cord layer over a full periphery of the cord layer, and the rubber layer has a width of 0.05-5.00 mm.

21. A pneumatic radial tire comprising a radial carcass comprised of at least one rubberized cord ply extending between a pair of bead cores embedded in a pair of bead portion and reinforcing a pair of sidewall portions and a tread portion, a belt reinforcing the tread portion at an outside of the carcass and comprised of three rubberized cord layers, an innermost cord layer and a middle cord layer among these cord layers being a cross cord layer that cords of the layers are crossed with each other with respect to an equatorial plane, and a pair of circumferential shoulder grooves formed on at least both side regions of the tread portion, characterized in that the cords of each of the innermost cord layer and the middle cord layer have an inclination angle of 10-25° with respect to the equatorial plane, and cords of an outermost cord layer are high-extensible cords and have an inclination angle of 45-115° with respect to the equatorial plane as measured in the same direction as in the cords of the middle cord layer, and the outermost cord layer has a width narrower than a width between groove edges of the circumferential shoulder grooves nearest to the equatorial plane.

22. A pneumatic radial tire according to claim 21, wherein a coating rubber for the cords of the outermost cord layer has a compression modulus of not less than 200 kgf/cm².

23. A pneumatic radial tire according to claim 21, wherein two circumferential central grooves extending so as to sandwich the equatorial plane of the tire therebetween are arranged in a central region of the tread portion and the width of the outermost cord layer is wider than a width between groove edges of the circumferential central grooves farthest from the equatorial plane.
